(19) United States
(12) Patent Application Publication
(10) Pub. No.: US 2026/0025719 A1
(43) Pub. Date: Jan. 22, 2026

(54) METHOD AND APPARATUS FOR HANDOVER BETWEEN NON-TERRESTRIAL NETWORK AND TERRESTRIAL NETWORK

(71) Applicants: Hyundai Motor Company, Seoul (KR); Kia Corporation, Seoul (KR); INHA UNIVERSITY RESEARCH AND BUSINESS FOUNDATION, Incheon (KR)

(72) Inventors: Young Kil SUH, Hwaseong-si, Gyeonggi-do (KR); Joo Hyun LEE, Hwaseong-si, Gyeonggi-do (KR); Ui Hyun HONG, Hwaseong-si, Gyeonggi-do (KR); Gene Back HAHN, Hwaseong-si, Gyeonggi-do (KR); Hyun Jin KIM, Hwaseong-si, Gyeonggi-do (KR); Duk Kyung KIM, Seoul (KR)

(73) Assignees: Hyundai Motor Company, Seoul (KR); Kia Corporation, Seoul (KR); INHA UNIVERSITY RESEARCH AND BUSINESS FOUNDATION, Incheon (KR)

(21) Appl. No.: 18/995,521

(22) PCT Filed: Aug. 30, 2023
(86) PCT No.: PCT/KR2023/012856

§ 371 Date: Jan. 16, 2025

(30) Foreign Application Priority Data
Aug. 30, 2022 (KR) 10-2022-0109476

(51) Int. Cl. H04W 36/00

(52) U.S. Cl. CPC H04W 36/0085; H04W 36/00837

(57) ABSTRACT

A technology for handover between a non-terrestrial network and a terrestrial network may be provided. This method for a user equipment (UE) may be provided, the method comprising the steps of: determining whether or not a measurement triggering condition for measurement targets is satisfied; if the measurement triggering condition is satisfied as the result of the determination, measuring received signal strengths for the measurement targets; transmitting the measured received signal strengths to a base station; receiving, from the base station, a handover command based on the received signal strengths; and performing handover with one of the measurement targets, according to the handover command.

### TECHNICAL FIELD

The present disclosure relates to a technique for handover between a non-terrestrial network and a terrestrial network, and more particularly, to a technique for handover between a non-terrestrial network and a terrestrial network, which supports handover of a terminal in a boundary region of terrestrial network service coverages.

### BACKGROUND ART

A communication network (e.g. 5G communication network, 6G communication network, etc.) to provide enhanced communication services compared to the existing communication network (e.g. long term evolution (LTE), LTE-Advanced (LTA-A), etc.) is being developed. The 5G communication network (e.g. new radio (NR) communication network) can support not only a frequency band of 6 GHz or below, but also a frequency band of 6 GHz or above. That is, the 5G communication network can support a frequency range (FR1) band and/or FR2 band. The 5G communication network can support various communication services and scenarios compared to the LTE communication network. For example, usage scenarios of the 5G communication network may include enhanced Mobile BroadBand (eMBB), Ultra Reliable Low Latency Communication (URLLC), Massive Machine Type Communication (mMTC), and the like.

The 6G communication network can support a variety of communication services and scenarios compared to the 5G communication network. The 6G communication networks can meet the requirements of hyper-performance, hyper-bandwidth, hyper-space, hyper-precision, hyper-intelligence, and/or hyper-reliability. The 6G communication networks can support various and wide frequency bands and can be applied to various usage scenarios (e.g. terrestrial communication, non-terrestrial communication, sidelink communication, and the like).

The communication network (e.g. 5G communication network, 6G communication network, etc.) may provide communication services to terminals located on the ground. Recently, the demand for communication services for not only terrestrial but also non-terrestrial airplanes, drones, and satellites has been increasing, and for this purpose, technologies for a non-terrestrial network (NTN) have been discussed. The non-terrestrial network may be implemented based on 5G communication technology, 6G communication technology, and/or the like. For example, in the non-terrestrial network, communication between a satellite and a terrestrial communication node or a non-terrestrial communication node (e.g. airplane, drone, or the like) may be performed based on 5G communication technology, 6G communication technology, and/or the like. In the NTN, the satellite may perform functions of a base station in a communication network (e.g. 5G communication network, 6G communication network, and/or the like).

Meanwhile, a handover method between a non-terrestrial network and a terrestrial network may be required. Such a handover method may include a handover method from a terrestrial network to a non-terrestrial network and a handover method from a non-terrestrial network to a terrestrial network. These handover methods may require aspects such as measurement triggering for a handover, measurement complexity, signaling based on measurement value reporting, and methods for determining a handover timing.

### DISCLOSURE

### Technical Problem

The present disclosure is directed to providing a method and an apparatus for handover between a non-terrestrial network and a terrestrial network, which supports handover of a terminal in a service boundary region of TN cells.

### Technical Solution

A handover method between a non-terrestrial network and a terrestrial network, according to a first exemplary embodiment of the present disclosure for achieving the above-described objective, may comprise the following steps as performed by a user equipment (UE): determining whether a measurement triggering condition for measurement objects is satisfied; in response to the measurement triggering condition being determined to be satisfied, measuring reception signal strengths for the measurement objects; transmitting the measured reception signal strengths to a base station; receiving, from the base station, a handover command based on the reception signal strengths; and performing a handover with one of the measurement objects according to the handover command, wherein the measurement objects may be terrestrial network base stations, and the base station may be one of a non-terrestrial network base station and a terrestrial network base station.

The measurement objects may further include non-terrestrial network base stations.

The determining of whether the measurement triggering condition for measurement objects is satisfied may comprise: receiving a measurement triggering signal for the measurement objects; and in response to receipt of the measurement triggering signal, determining whether the measurement triggering condition is satisfied.

The determining of whether the measurement triggering condition for measurement objects is satisfied may comprise: determining whether the UE is close to a service boundary region of the measurement objects; and determining whether the measurement triggering condition is satisfied based on whether the UE is close to the service boundary region of the measurement objects.

Whether the UE is closed to the service boundary region may be determined based on at least one of information on locations of the measurement objects, information on locations of service coverages of the measurement objects, or information on cell radii of the measurement objects, and location information of the UE.

The measuring of the reception signal strengths for the measurement objects may comprise: in response to the measurement triggering condition being determined to be satisfied, determining a measurement time by considering a movement speed and direction of the UE; and measuring the reception signal strengths for the measurement objects at the determined measurement time.

A handover method between a non-terrestrial network and a terrestrial network, according to a second exemplary embodiment of the present disclosure for achieving the above-described objective, may comprise the following steps as performed by a first base station: determining whether a measurement triggering condition for measurement objects is satisfied; in response to the measurement triggering condition being determined to be satisfied, transmitting a measurement triggering signal for the measurement objects to a user equipment (UE); receiving, from the UE, measured reception signal strengths for the measurement objects: transmitting, to a second base station, a handover request based on the reception signal strengths; receiving a handover response to the handover request from the second base station; and transmitting a handover command to the UE based on the handover response.

The measurement objects may be terrestrial network base stations, and the first base station may be a first non-terrestrial network base station.

The measurement objects may be terrestrial network base stations and non-terrestrial network base stations, and the first base station may be a terrestrial network base station.

The determining of whether the measurement triggering condition for measurement objects is satisfied may comprise: determining whether the UE is close to a service boundary region of the measurement objects; and determining whether the measurement triggering condition is satisfied based on whether the UE is close to the service boundary region.

Whether the UE is close to the service boundary region may be determined based on at least one of information on locations of the measurement objects, information on locations of service coverages of the measurement objects, or information on cell radii of the measurement objects, and location information of the UE.

The transmitting of the handover request based on the reception signal strengths to the second base station may comprise: determining whether the reception signal strengths are less than a threshold; in response to the reception signal strengths being determined to be less than the threshold, deciding a handover; and transmitting a handover request to the second base station, which is one of the measurement objects.

The transmitting of the handover request based on the reception signal strengths to the second base station may comprise: determining whether reception signal strengths of terrestrial network base stations among the reception signal strengths are less than a first threshold; in response to the reception signal strengths of the terrestrial network base stations being determined to be less than the first threshold, determining whether there is a reception signal strength of at least one non-terrestrial network base station among the reception signal strengths that exceeds a second threshold; and transmitting a handover request to the second base station, which is the at least one non-terrestrial network base station that exceeds the second threshold.

A handover apparatus between a non-terrestrial network and a terrestrial network, according to a first exemplary embodiment of the present disclosure for achieving the above-described objective, may comprise an apparatus configured for a user equipment (UE), the apparatus including at least one processor, wherein the at least one processor causes the UE to perform; determining whether a measurement triggering condition for measurement objects is satisfied; in response to the measurement triggering condition being determined to be satisfied, measuring reception signal strengths for the measurement objects; transmitting the measured reception signal strengths to a base station: receiving, from the base station, a handover command based on the reception signal strengths; and performing a handover with one of the measurement objects according to the handover command, wherein the measurement objects may be terrestrial network base stations, and the base station may be one of a non-terrestrial network base station and a terrestrial network base station.

In the determining of whether the measurement triggering condition for measurement objects is satisfied, the at least one processor may further cause the UE to perform: receiving a measurement triggering signal for the measurement objects: and in response to receipt of the measurement triggering signal, determining whether the measurement triggering condition is satisfied.

In the determining of whether the measurement triggering condition for measurement objects is satisfied, the at least one processor may further cause the UE to perform; determining whether the UE is close to a service boundary region of the measurement objects; and determining whether the measurement triggering condition is satisfied based on whether the UE is close to the service boundary region of the measurement objects.

In the measuring of the reception signal strengths for the measurement objects, the at least one processor may further cause the UE to perform: in response to the measurement triggering condition being determined to be satisfied, determining a measurement time by considering a movement speed and direction of the UE; and measuring the reception signal strengths for the measurement objects at the determined measurement time.

### Advantageous Effects

According to the present disclosure, handovers can be supported when a terminal moves from non-terrestrial network service coverage to terrestrial network service coverage. Additionally, handovers can be supported when a terminal moves from terrestrial network service coverage to non-terrestrial network service coverage. Furthermore, the terminal can initiate measurements for handover when it is near terrestrial network service coverage, thereby reducing the measurement burden on the terminal. Moreover, the terminal can perform a handover to a non-terrestrial base station if the received signal strength of terrestrial base stations is below a first threshold, and the received signal strength of a non-terrestrial base station exceeds a second threshold.

### DESCRIPTION OF DRAWINGS

FIG. 1A is a conceptual diagram illustrating a first exemplary embodiment of a non-terrestrial network.

FIG. 1B is a conceptual diagram illustrating a second exemplary embodiment of a non-terrestrial network.

FIG. 2A is a conceptual diagram illustrating a third exemplary embodiment of a non-terrestrial network.

FIG. 2B is a conceptual diagram illustrating a fourth exemplary embodiment of a non-terrestrial network.

FIG. 2C is a conceptual diagram illustrating a fifth exemplary embodiment of a non-terrestrial network.

FIG. 3 is a block diagram illustrating a first exemplary embodiment of a communication node constituting a non-terrestrial network.

FIG. 4 is a block diagram illustrating a first exemplary embodiment of communication nodes performing communication.

FIG. 5A is a block diagram illustrating a first exemplary embodiment of a transmission path.

FIG. 5B is a block diagram illustrating a first exemplary embodiment of a reception path.

FIG. 6A is a conceptual diagram illustrating a first exemplary embodiment of a protocol stack of a user plane in a transparent payload-based non-terrestrial network.

FIG. 6B is a conceptual diagram illustrating a first exemplary embodiment of a protocol stack of a control plane in a transparent payload-based non-terrestrial network.

FIG. 7A is a conceptual diagram illustrating a first exemplary embodiment of a protocol stack of a user plane in a regenerative payload-based non-terrestrial network.

FIG. 7B is a conceptual diagram illustrating a first exemplary embodiment of a protocol stack of a control plane in a regenerative payload-based non-terrestrial network.

FIG. 8 is a sequence chart illustrating a first exemplary embodiment of a handover procedure.

FIG. 9 is a conceptual diagram illustrating a first exemplary embodiment of a change in RSRP according to a distance from a cell center in a terrestrial network.

FIG. 10 is a conceptual diagram illustrating a first exemplary embodiment of a change in RSRP according to a distance from a cell center in a non-terrestrial network.

FIG. 11 is a conceptual diagram illustrating a path difference according to a location of a terminal within a beam coverage.

FIG. 12 is a conceptual diagram illustrating a first exemplary embodiment of a change in an earth-moving beam coverage in a multi-beam environment.

FIG. 13 is a conceptual diagram illustrating a first exemplary embodiment of a change in an earth-fixed beam coverage in a multi-beam environment.

FIG. 14 is a conceptual diagram illustrating a first exemplary embodiment of a handover scenario.

FIG. 15 is a conceptual diagram illustrating a second exemplary embodiment of a handover scenario.

FIG. 16 is a sequence chart illustrating a first exemplary embodiment of a handover method between NTN and TN.

FIG. 17 is a sequence chart illustrating a second exemplary embodiment of a handover method between NTN and TN.

FIG. 18 is a sequence chart illustrating a third exemplary embodiment of a handover method between NTN and TN.

FIG. 19 is a sequence chart illustrating a fourth exemplary embodiment of a handover method between NTN and TN.

FIG. 20 is a sequence chart illustrating a fifth exemplary embodiment of a handover method between NTN and TN.

FIG. 21 is a sequence chart illustrating a sixth exemplary embodiment of a handover method between NTN and TN.

FIG. 22 is a conceptual diagram illustrating a third exemplary embodiment of a handover scenario.

### BEST MODE OF THE INVENTION

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In the present disclosure, “at least one of A and B” may mean “at least one of A or B” or “at least one of combinations of one or more of A and B”. Also, in exemplary embodiments of the present disclosure, “one or more of A and B” may mean “one or more of A or B” or “one or more of combinations of one or more of A and B”.

In the present disclosure, “(re)transmission” may refer to “transmission”, “retransmission”, or “transmission and retransmission”, “(re)configuration” may refer to “configuration”, “reconfiguration”, or “configuration and reconfiguration”, “(re)connection” may refer to “connection”, “reconnection”, or “connection and reconnection”, and “(re)access” may mean “access”, “re-access”, or “access and re-access”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The terminology used herein is for the purpose of describing particular embodiments only and is not intended to be limiting of the present disclosure. As used herein, the singular forms are intended to include the plural forms as well, unless the context clearly indicates otherwise. It will be further understood that the terms “comprise” and/or “include” when used herein, specify the presence of stated features, integers, steps, operations, elements, components or combinations thereof, but do not preclude the presence or addition of one or more other features, integers, steps, operations, elements, components, and/or combinations thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted. In addition to the exemplary embodiments explicitly described in the present disclosure, operations may be performed according to a combination of the exemplary embodiments, extensions of the exemplary embodiments, and/or modifications of the exemplary embodiments. Performance of some operations may be omitted, and the order of performance of operations may be changed.

Even when a method (e.g. transmission or reception of a signal) performed at a first communication node among communication nodes is described, a corresponding second communication node may perform a method (e.g. reception or transmission of the signal) corresponding to the method performed at the first communication node. That is, when an operation of a user equipment (UE) is described, a base station corresponding to the UE may perform an operation corresponding to the operation of the UE. Conversely, when an operation of a base station is described, a UE corresponding to the base station may perform an operation corresponding to the operation of the base station. In a non-terrestrial network (NTN) (e.g. payload-based NTN), operations of a base station may refer to operations of a satellite, and operations of a satellite may refer to operations of a base station.

The base station may refer to a NodeB, evolved NodeB (eNodeB), next generation node B (gNodeB), gNB, device, apparatus, node, communication node, base transceiver station (BTS), radio remote head (RRH), transmission reception point (TRP), radio unit (RU), road side unit (RSU), radio transceiver, access point, access node, and/or the like. The UE may refer to a terminal, device, apparatus, node, communication node, end node, access terminal, mobile terminal, station, subscriber station, mobile station, portable subscriber station, on-broad unit (OBU), and/or the like.

In the present disclosure, signaling may be at least one of higher layer signaling, medium access control (MAC) signaling, or physical (PHY) signaling. Messages used for higher layer signaling may be referred to as ‘higher layer messages’ or ‘higher layer signaling messages’. Messages used for MAC signaling may be referred to as ‘MAC messages’ or ‘MAC signaling messages’. Messages used for PHY signaling may be referred to as ‘PHY messages’ or ‘PHY signaling messages’. The higher layer signaling may refer to a transmission and reception operation of system information (e.g. master information block (MIB), system information block (SIB)) and/or RRC messages. The MAC signaling may refer to a transmission and reception operation of a MAC control element (CE). The PHY signaling may refer to a transmission and reception operation of control information (e.g. downlink control information (DCI), uplink control information (UCI), and sidelink control information (SCI)).

In the present disclosure, “an operation (e.g. transmission operation) is configured” may mean that “configuration information (e.g. information element(s) or parameter(s)) for the operation and/or information indicating to perform the operation is signaled”. “Information element(s) (e.g. parameter(s)) are configured” may mean that “corresponding information element(s) are signaled”. In the present disclosure, “signal and/or channel” may mean a signal, a channel, or “signal and channel,” and “signal” may be used to mean “signal and/or channel”.

A communication system may include at least one of a terrestrial network, non-terrestrial network, 4G communication network (e.g. long-term evolution (LTE) communication network), 5G communication network (e.g. new radio (NR) communication network), or 6G communication network. Each of the 4G communications network, 5G communications network, and 6G communications network may include a terrestrial network and/or a non-terrestrial network. The non-terrestrial network may operate based on at least one communication technology among the LTE communication technology, 5G communication technology, or 6G communication technology. The non-terrestrial network may provide communication services in various frequency bands.

The communication network to which exemplary embodiments are applied is not limited to the content described below, and the exemplary embodiments may be applied to various communication networks (e.g. 4G communication network, 5G communication network, and/or 6G communication network). Here, communication network may be used in the same sense as a communication system.

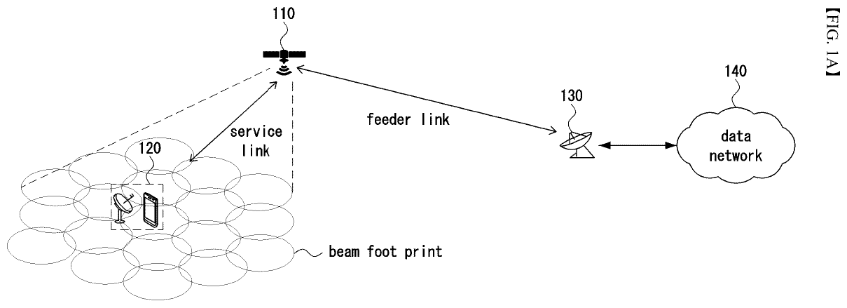

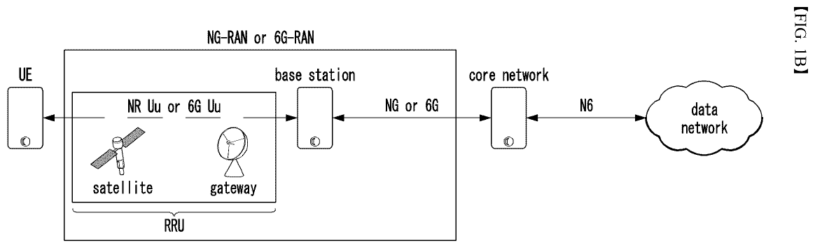

FIG. 1A is a conceptual diagram illustrating a first exemplary embodiment of a non-terrestrial network.

As shown in FIG. 1A, a non-terrestrial network (NTN) may include a satellite 110, a communication node 120, a gateway 130, a data network 140, and the like. A unit including the satellite 110 and the gateway 130 may correspond to a remote radio unit (RRU). The NTN shown in FIG. 1A may be an NTN based on a transparent payload. The satellite 110 may be a low earth orbit (LEO) satellite, a medium earth orbit (MEO) satellite, a geostationary earth orbit (GEO) satellite, a high elliptical orbit (HEO) satellite, or an unmanned aircraft system (UAS) platform. The UAS platform may include a high altitude platform station (HAPS). A non-GEO satellite may be an LEO satellite and/or MEO satellite.

The communication node 120 may include a communication node (e.g. a user equipment (UE) or a terminal) located on a terrestrial site and a communication node (e.g. an airplane, a drone) located on a non-terrestrial space. A service link may be established between the satellite 110 and the communication node 120, and the service link may be a radio link. The satellite 110 may be referred to as an NTN payload. The gateway 130 may support a plurality of NTN payloads. The satellite 110 may provide communication services to the communication node 120 using one or more beams. The shape of a footprint of the beam of the satellite 110 may be elliptical or circular.

In the non-terrestrial network, three types of service links can be supported as follows.
Earth-fixed: a service link may be provided by beam(s) that continuously cover the same geographic area at all times (e.g. geosynchronous orbit (GSO) satellite).
quasi-earth-fixed: a service link may be provided by beam(s) covering one geographical area during a limited period and provided by beam(s) covering another geographical area during another period (e.g. non-GSO (NGSO) satellite forming steerable beams).
earth-moving: a service link may be provided by beam(s) moving over the Earth's surface (e.g. NGSO satellite forming fixed beams or non-steerable beams).

The communication node 120 may perform communications (e.g. downlink communication and uplink communication) with the satellite 110 using 4G communication technology, 5G communication technology, and/or 6G communication technology. The communications between the satellite 110 and the communication node 120 may be performed using an NR-Uu interface and/or 6G-Uu interface. When dual connectivity (DC) is supported, the communication node 120 may be connected to other base stations (e.g. base stations supporting 4G, 5G, and/or 6G functionality) as well as the satellite 110, and perform DC operations based on the techniques defined in 4G, 5G, and/or 6G technical specifications.

The gateway 130 may be located on a terrestrial site, and a feeder link may be established between the satellite 110 and the gateway 130. The feeder link may be a radio link. The gateway 130 may be referred to as a ‘non-terrestrial network (NTN) gateway’. The communications between the satellite 110 and the gateway 130 may be performed based on an NR-Uu interface, a 6G-Uu interface, or a satellite radio interface (SRI). The gateway 130 may be connected to the data network 140. There may be a ‘core network’ between the gateway 130 and the data network 140. In this case, the gateway 130 may be connected to the core network, and the core network may be connected to the data network 140. The core network may support the 4G communication technology, 5G communication technology, and/or 6G communication technology. For example, the core network may include an access and mobility management function (AMF), a user plane function (UPF), a session management function (SMF), and the like. The communications between the gateway 130 and the core network may be performed based on an NG-C/U interface or 6G-C/U interface.

As shown in an exemplary embodiment of FIG. 1B, there may be a ‘core network’ between the gateway 130 and the data network 140 in a transparent payload-based NTN.

FIG. 1B is a conceptual diagram illustrating a second exemplary embodiment of a non-terrestrial network.

As shown in FIG. 1B, the gateway may be connected with the base station, the base station may be connected with the core network, and the core network may be connected with the data network. Each of the base station and core network may support the 4G communication technology, 5G communication technology, and/or 6G communication technology. The communications between the gateway and the base station may be performed based on an NR-Uu interface or 6G-Uu interface, and the communications between the base station and the core network (e.g. AMF, UPF, SMF, and the like) may be performed based on an NG-C/U interface or 6G-C/U interface.

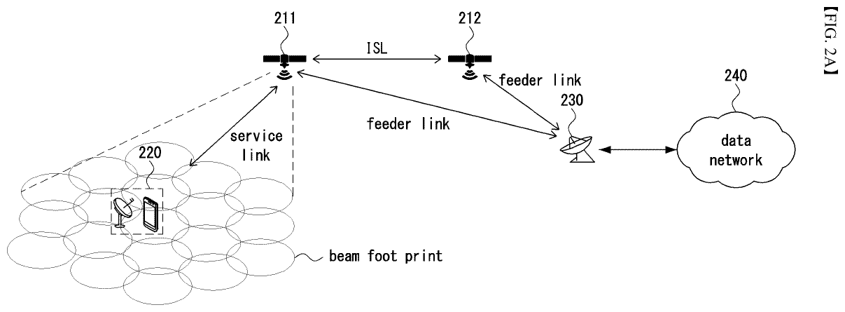

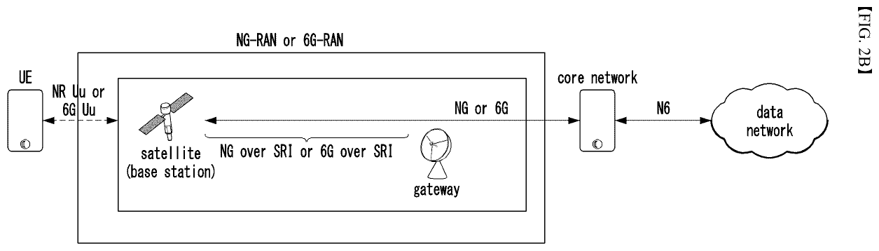

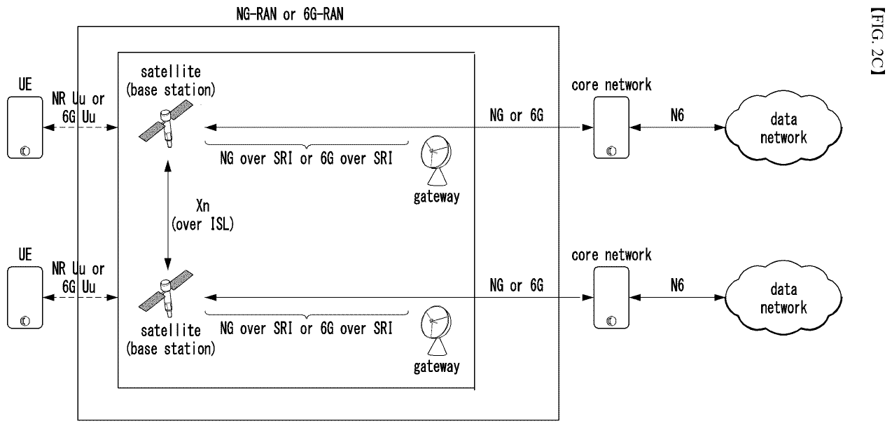

FIG. 2A is a conceptual diagram illustrating a third exemplary embodiment of a non-terrestrial network.

As shown in FIG. 2A, a non-terrestrial network may include a first satellite 211, a second satellite 212, a communication node 220, a gateway 230, a data network 240, and the like. The NTN shown in FIG. 2A may be a regenerative payload based NTN. For example, each of the satellites 211 and 212 may perform a regenerative operation (e.g. demodulation, decoding, re-encoding, re-modulation, and/or filtering operation) on a payload received from other entities (e.g. the communication node 220 or the gateway 230), and transmit the regenerated payload.

Each of the satellites 211 and 212 may be a LEO satellite, a MEO satellite, a GEO satellite, a HEO satellite, or a UAS platform. The UAS platform may include a HAPS. The satellite 211 may be connected to the satellite 212, and an inter-satellite link (ISL) may be established between the satellite 211 and the satellite 212. The ISL may operate in an RF frequency band or an optical band. The ISL may be established optionally. The communication node 220 may include a terrestrial communication node (e.g. UE or terminal) and a non-terrestrial communication node (e.g. airplane or drone). A service link (e.g. radio link) may be established between the satellite 211 and communication node 220. The satellite 211 may be referred to as an NTN payload. The satellite 211 may provide communication services to the communication node 220 using one or more beams.

The communication node 220 may perform communications (e.g. downlink communication or uplink communication) with the satellite 211 using the 4G communication technology, 5G communication technology, and/or 6G communication technology. The communications between the satellite 211 and the communication node 220 may be performed using an NR-Uu interface or 6G-Uu interface. When DC is supported, the communication node 220 may be connected to other base stations (e.g. base stations supporting 4G, 5G, and/or 6G functionality) as well as the satellite 211, and may perform DC operations based on the techniques defined in 4G, 5G, and/or 6G technical specifications.

The gateway 230 may be located on a terrestrial site, a feeder link may be established between the satellite 211 and the gateway 230, and a feeder link may be established between the satellite 212 and the gateway 230. The feeder link may be a radio link. When the ISL is not established between the satellite 211 and the satellite 212, the feeder link between the satellite 211 and the gateway 230 may be established mandatorily. The communications between each of the satellites 211 and 212 and the gateway 230 may be performed based on an NR-Uu interface, a 6G-Uu interface, or an SRI. The gateway 230 may be connected to the data network 240.

As shown in exemplary embodiments of FIG. 2B and FIG. 2C, there may be a ‘core network’ between the gateway 230 and the data network 240.

FIG. 2B is a conceptual diagram illustrating a fourth exemplary embodiment of a non-terrestrial network, and FIG. 2C is a conceptual diagram illustrating a fifth exemplary embodiment of a non-terrestrial network.

As shown in FIG. 2B and FIG. 2C, the gateway may be connected with the core network, and the core network may be connected with the data network. The core network may support the 4G communication technology, 5G communication technology, and/or 6G communication technology. For example. The core network may include AMF, UPF, SMF, and the like. Communication between the gateway and the core network may be performed based on an NG-C/U interface or 6G-C/U interface. Functions of a base station may be performed by the satellite. That is, the base station may be located on the satellite. The base station located on the satellite may be a base station-distributed unit (DU), and a base station-centralized unit (CU) may be located within NG-RAN or 6G-RAN. A payload may be processed by the base station located on the satellite. Base stations located on different satellites may be connected to the same core network. One satellite may have one or more base stations. In the non-terrestrial network of FIG. 2B, an ISL between satellites may not be established, and in the non-terrestrial network of FIG. 2C, an ISL between satellites may be established.

Meanwhile, the entities (e.g. satellite, base station, UE, communication node, gateway, and the like) constituting the non-terrestrial network shown in FIGS. 1A, 1B, 2A, 2B, and/or 2C may be configured as follows. In the present disclosure, the entity may be referred to as a communication node.

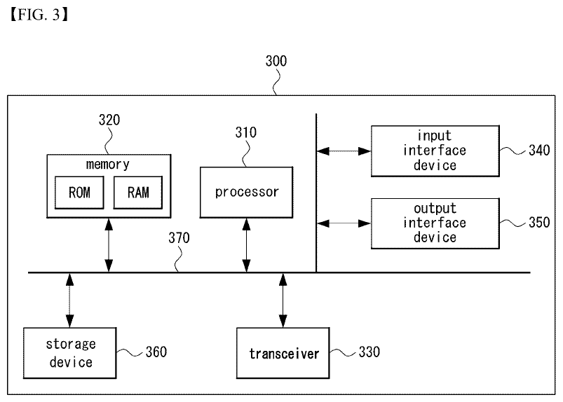

FIG. 3 is a block diagram illustrating a first exemplary embodiment of a communication node constituting a non-terrestrial network.

As shown in FIG. 3, a communication node 300 may include at least one processor 310, a memory 320, and a transceiver 330 connected to a network to perform communication. In addition, the communication node 300 may further include an input interface device 340, an output interface device 350, a storage device 360, and the like. The components included in the communication node 300 may be connected by a bus 370 to communicate with each other.

However, each component included in the communication node 300 may be connected to the processor 310 through a separate interface or a separate bus instead of the common bus 370. For example, the processor 310 may be connected to at least one of the memory 320, the transceiver 330, the input interface device 340, the output interface device 350, and the storage device 360 through a dedicated interface.

The processor 310 may execute at least one instruction stored in at least one of the memory 320 and the storage device 360. The processor 310 may refer to a central processing unit (CPU), a graphics processing unit (GPU), or a dedicated processor on which the methods according to the exemplary embodiments of the present disclosure are performed. Each of the memory 320 and the storage device 360 may be configured as at least one of a volatile storage medium and a nonvolatile storage medium. For example, the memory 320 may be configured with at least one of a read only memory (ROM) and a random access memory (RAM).

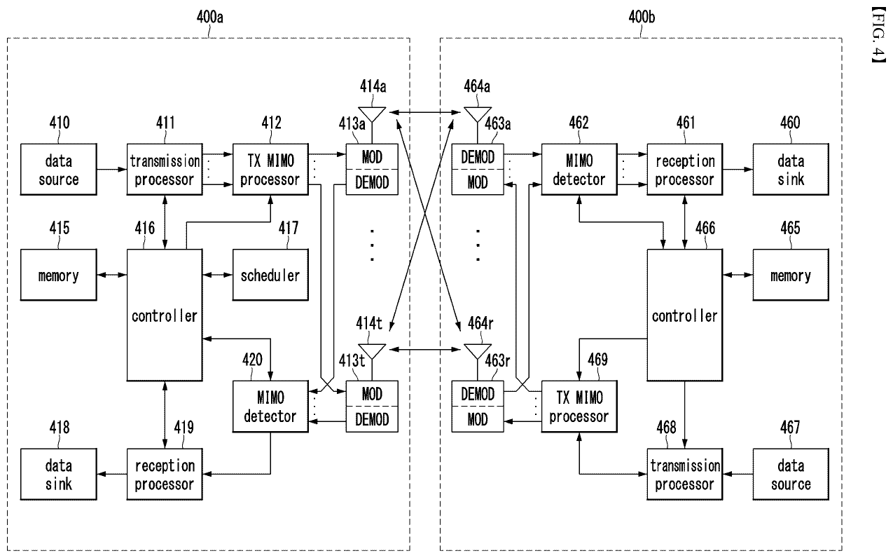

Meanwhile, communication nodes that perform communications in the communication network (e.g. non-terrestrial network) may be configured as follows. A communication node shown in FIG. 4 may be a specific exemplary embodiment of the communication node shown in FIG. 3.

FIG. 4 is a block diagram illustrating a first exemplary embodiment of communication nodes performing communication.

As shown in FIG. 4, each of a first communication node 400a and a second communication node 400b may be a base station or UE. The first communication node 400a may transmit a signal to the second communication node 400b. A transmission processor 411 included in the first communication node 400a may receive data (e.g. data unit) from a data source 410. The transmission processor 411 may receive control information from a controller 416. The control information may include at least one of system information, RRC configuration information (e.g. information configured by RRC signaling), MAC control information (e.g. MAC CE), or PHY control information (e.g. DCI, SCI).

The transmission processor 411 may generate data symbol(s) by performing processing operations (e.g. encoding operation, symbol mapping operation, etc.) on the data. The transmission processor 411 may generate control symbol(s) by performing processing operations (e.g. encoding operation, symbol mapping operation, etc.) on the control information. In addition, the transmission processor 411 may generate synchronization/reference symbol(s) for synchronization signals and/or reference signals.

A Tx MIMO processor 412 may perform spatial processing operations (e.g. precoding operations) on the data symbol(s), control symbol(s), and/or synchronization/reference symbol(s). An output (e.g. symbol stream) of the Tx MIMO processor 412 may be provided to modulators (MODs) included in transceivers 413a to 413t. The modulator may generate modulation symbols by performing processing operations on the symbol stream, and may generate signals by performing additional processing operations (e.g. analog conversion operations, amplification operation, filtering operation, up-conversion operation, etc.) on the modulation symbols. The signals generated by the modulators of the transceivers 413a to 413t may be transmitted through antennas 414a to 414t.

The signals transmitted by the first communication node 400a may be received at antennas 464a to 464r of the second communication node 400b. The signals received at the antennas 464a to 464r may be provided to demodulators (DEMODs) included in transceivers 463a to 463r. The demodulator (DEMOD) may obtain samples by performing processing operations (e.g. filtering operation, amplification operation, down-conversion operation, digital conversion operation, etc.) on the signals. The demodulator may perform additional processing operations on the samples to obtain symbols. A MIMO detector 462 may perform MIMO detection operations on the symbols. A reception processor 461 may perform processing operations (e.g. de-interleaving operation, decoding operation, etc.) on the symbols. An output of the reception processor 461 may be provided to a data sink 460 and a controller 466. For example, the data may be provided to the data sink 460 and the control information may be provided to the controller 466.

On the other hand, the second communication node 400b may transmit signals to the first communication node 400a. A transmission processor 469 included in the second communication node 400b may receive data (e.g. data unit) from a data source 467 and perform processing operations on the data to generate data symbol(s). The transmission processor 468 may receive control information from the controller 466 and perform processing operations on the control information to generate control symbol(s). In addition, the transmission processor 468 may generate reference symbol(s) by performing processing operations on reference signals.

A Tx MIMO processor 469 may perform spatial processing operations (e.g. precoding operations) on the data symbol(s), control symbol(s), and/or reference symbol(s). An output (e.g. symbol stream) of the Tx MIMO processor 469 may be provided to modulators (MODs) included in the transceivers 463a to 463t. The modulator may generate modulation symbols by performing processing operations on the symbol stream, and may generate signals by performing additional processing operations (e.g. analog conversion operation, amplification operation, filtering operation, up-conversion operations) on the modulation symbols. The signals generated by the modulators of the transceivers 463a to 463t may be transmitted through the antennas 464a to 464t.

The signals transmitted by the second communication node 400b may be received at the antennas 414a to 414r of the first communication node 400a. The signals received at the antennas 414a to 414r may be provided to demodulators (DEMODs) included in the transceivers 413a to 413r. The demodulator may obtain samples by performing processing operations (e.g. filtering operation, amplification operation, down-conversion operation, digital conversion operation) on the signals. The demodulator may perform additional processing operations on the samples to obtain symbols. A MIMO detector 420 may perform a MIMO detection operation on the symbols. The reception processor 419 may perform processing operations (e.g. de-interleaving operation, decoding operation, etc.) on the symbols. An output of the reception processor 419 may be provided to a data sink 418 and the controller 416. For example, the data may be provided to the data sink 418 and the control information may be provided to the controller 416.

Memories 415 and 465 may store the data, control information, and/or program codes. A scheduler 417 may perform scheduling operations for communication. The processors 411, 412, 419, 461, 468, and 469 and the controllers 416 and 466 shown in FIG. 4 may be the processor 310 shown in FIG. 3, and may be used to perform methods described in the present disclosure.

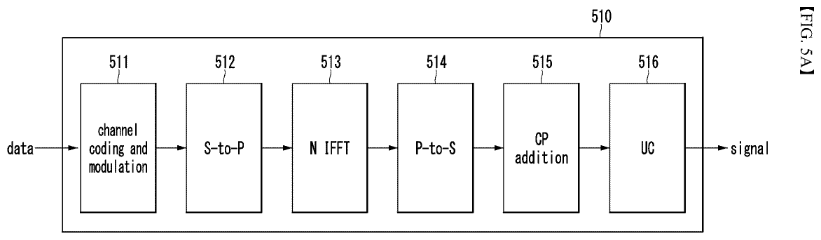

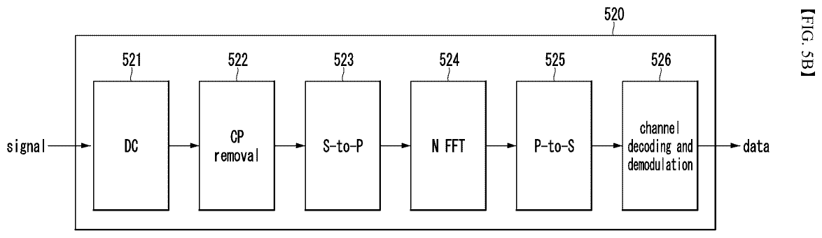

FIG. 5A is a block diagram illustrating a first exemplary embodiment of a transmission path, and FIG. 5B is a block diagram illustrating a first exemplary embodiment of a reception path.

As shown in FIGS. 5A and 5B, a transmission path 510 may be implemented in a communication node that transmits signals, and a reception path 520 may be implemented in a communication node that receives signals. The transmission path 510 may include a channel coding and modulation block 511, a serial-to-parallel (S-to-P) block 512, an N-point inverse fast Fourier transform (N-point IFFT) block 513, a parallel-to-serial (P-to-S) block 514, a cyclic prefix (CP) addition block 515, and up-converter (UC) 516. The reception path 520 may include a down-converter (DC) 521, a CP removal block 522, an S-to-P block 523, an N-point FFT block 524, a P-to-S block 525, and a channel decoding and demodulation block 526. Here, N may be a natural number.

In the transmission path 510, information bits may be input to the channel coding and modulation block 511. The channel coding and modulation block 511 may perform a coding operation (e.g. low-density parity check (LDPC) coding operation, polar coding operation, etc.) and a modulation operation (e.g. Quadrature Phase Shift Keying (OPSK), Quadrature Amplitude Modulation (QAM), etc.) on the information bits. An output of the channel coding and modulation block 511 may be a sequence of modulation symbols.

The S-to-P block 512 may convert frequency domain modulation symbols into parallel symbol streams to generate N parallel symbol streams. N may be the IFFT size or the FFT size. The N-point IFFT block 513 may generate time domain signals by performing an IFFT operation on the N parallel symbol streams. The P-to-S block 514 may convert the output (e.g., parallel signals) of the N-point IFFT block 513 to serial signals to generate the serial signals.

The CP addition block 515 may insert a CP into the signals. The UC 516 may up-convert a frequency of the output of the CP addition block 515 to a radio frequency (RF) frequency. Further, the output of the CP addition block 515 may be filtered in baseband before the up-conversion.

The signal transmitted from the transmission path 510 may be input to the reception path 520. Operations in the reception path 520 may be reverse operations for the operations in the transmission path 510. The DC 521 may down-convert a frequency of the received signals to a baseband frequency. The CP removal block 522 may remove a CP from the signals. The output of the CP removal block 522 may be serial signals. The S-to-P block 523 may convert the serial signals into parallel signals. The N-point FFT block 524 may generate N parallel signals by performing an FFT algorithm. The P-to-S block 525 may convert the parallel signals into a sequence of modulation symbols. The channel decoding and demodulation block 526 may perform a demodulation operation on the modulation symbols and may restore data by performing a decoding operation on a result of the demodulation operation.

In FIGS. 5A and 5B, discrete Fourier transform (DFT) and inverse DFT (IDFT) may be used instead of FFT and IFFT. Each of the blocks (e.g. components) in FIGS. 5A and 5B may be implemented by at least one of hardware, software, or firmware. For example, some blocks in FIGS. 5A and 5B may be implemented by software, and other blocks may be implemented by hardware or a combination of hardware and software. In FIGS. 5A and 5B, one block may be subdivided into a plurality of blocks, a plurality of blocks may be integrated into one block, some blocks may be omitted, and blocks supporting other functions may be added.

Meanwhile, NTN reference scenarios may be defined as shown in Table 1 below.

TABLE 1

| | NTN shown in FIG. 1 | NTN shown in FIG. 2 |
|---|---|---|
| GEO | Scenario A | Scenario B |
| LEO (steerable beams) | Scenario C1 | Scenario D1 |
| LEO (beams moving | Scenario C2 | Scenario D2 |
| with satellite) | | |

When the satellite 110 in the NTN shown in FIG. 1A and/or FIG. 1B is a GEO satellite (e.g. a GEO satellite that supports a transparent function), this may be referred to as ‘scenario A’. When the satellites 211 and 212 in the NTN shown in FIG. 2A, FIG. 2B, and/or FIG. 2C are GEO satellites (e.g. GEOs that support a regenerative function), this may be referred to as ‘scenario B’.

When the satellite 110 in the NTN shown in FIG. 1A and/or FIG. 1B is an LEO satellite with steerable beams, this may be referred to as ‘scenario C1’. When the satellite 110 in the NTN shown in FIG. 1A and/or FIG. 1B is an LEO satellite having beams moving with the satellite, this may be referred to as ‘scenario C2’. When the satellites 211 and 212 in the NTN shown in FIG. 2A, FIG. 2B, and/or FIG. 2C are LEO satellites with steerable beams, this may be referred to as ‘scenario D1’. When the satellites 211 and 212 in the NTN shown in FIG. 2A, FIG. 2B, and/or FIG. 2C are LEO satellites having beams moving with the satellites, this may be referred to as ‘scenario D2’.

Parameters for the NTN reference scenarios defined in Table 1 may be defined as shown in Table 2 below.

TABLE 2

| | Scenarios A and B | Scenarios C and D |
|---|---|---|
| Altitude | 35,786 km | 600 km |
| | | 1,200 km |
| Spectrum (service | <6 GHz (e.g. 2 GHz) | |
| link) | >6 GHz (e.g. DL 20 GHz, UL 30 GHz) | |
| Maximum channel | 30 MHz for band <6 GHz | |
| bandwidth capability | 1 GHz for band >6 GHz | |
| (service link) | | |
| Maximum distance | 40,581 km | 1,932 km (altitude of |
| between satellite and | | 600 km) |
| communication node (e.g. | | 3,131 km (altitude of |
| UE) at the minimum | | 1,200 km) |
| elevation angle | | |
| Maximum round trip | Scenario A: 541.46 | Scenario C: |
| delay (RTD) | ms (service and feeder | (transparent payload: service |
| (only propagation | links) | and feeder links) |
| delay) | Scenario B: 270.73 | −5.77 ms (altitude of |
| | ms (only service link) | 60 0 km) |
| | | −41.77 ms (altitude of |
| | | 1,200 km) |
| | | Scenario D: |
| | | (regenerative payload: only |
| | | service link) |
| | | −12.89 ms (altitude of |
| | | 600 km) |
| | | −20.89 ms (altitude of |
| | | 1,200 km) |
| Maximum | 10.3 ms | 3.12 ms (altitude of |
| differential delay within a | | 600 km) |
| cell | | 3.18 ms (altitude of |
| | | 1,200 km) |

| | |
|---|---|
| Service link | NR defined in 3GPP |
| Feeder link | Radio interfaces defined in 3GPP or non-3GPP |

In addition, in the scenarios defined in Table 1, delay constraints may be defined as shown in Table 3 below.

TABLE 3

| | Scenario A | Scenario B | Scenario C1-2 | | Scenario D1-2 | |
|---|---|---|---|---|---|---|
| Satellite altitude | 35,786 km | | 600 km | | | |
| Maximum RTD in a | 541.75 ms | 270.57 ms | 28.41 | ms | 12.88 | ms |
| radio interface | (worst case) | | | | | |
| between base station | | | | | | |
| and UE | | | | | | |
| Minimum RTD in a | 477.14 ms | 238.57 ms | 8 | ms | 4 | ms |
| radio interface | | | | | | |
| between base station | | | | | | |
| and UE | | | | | | |

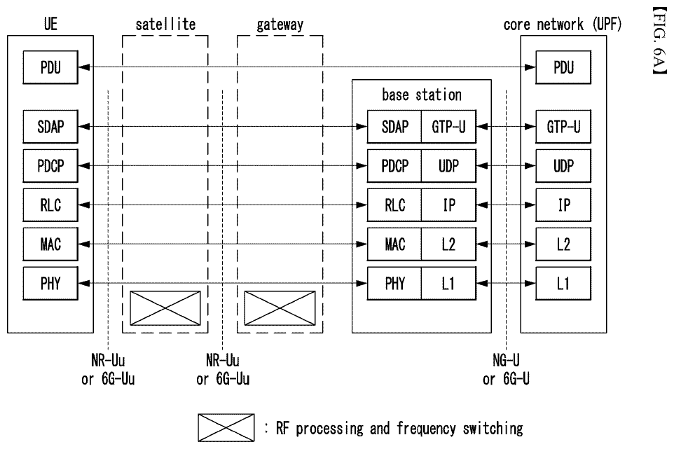

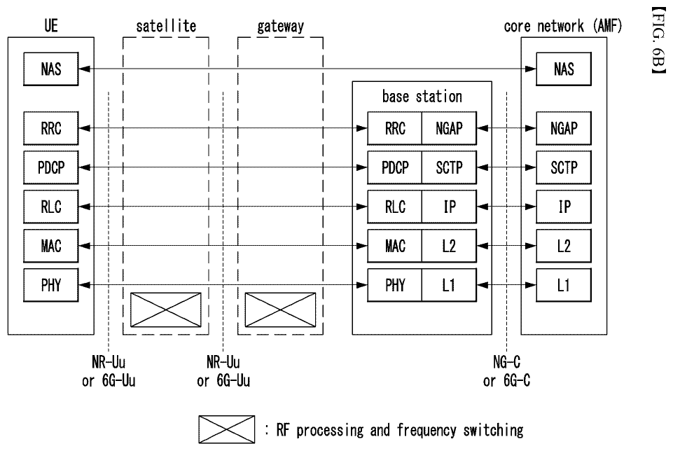

FIG. 6A is a conceptual diagram illustrating a first exemplary embodiment of a protocol stack of a user plane in a transparent payload-based non-terrestrial network, and FIG. 6B is a conceptual diagram illustrating a first exemplary embodiment of a protocol stack of a control plane in a transparent payload-based non-terrestrial network.

As shown in FIGS. 6A and 6B, user data may be transmitted and received between a UE and a core network (e.g. UPF), and control data (e.g. control information) may be transmitted and received between the UE and the core network (e.g. AMF). Each of the user data the and control data may be transmitted and received through a satellite and/or gateway. The protocol stack of the user plane shown in FIG. 6A may be applied identically or similarly to a 6G communication network. The protocol stack of the control plane shown in FIG. 6B may be applied identically or similarly to a 6G communication network.

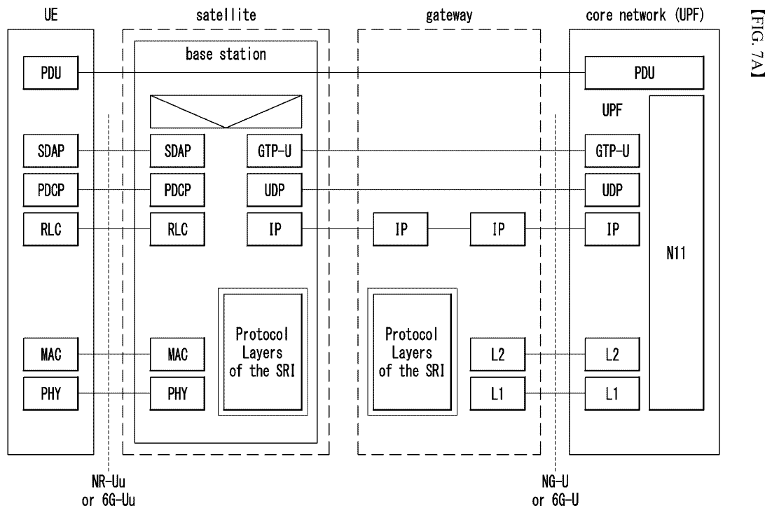

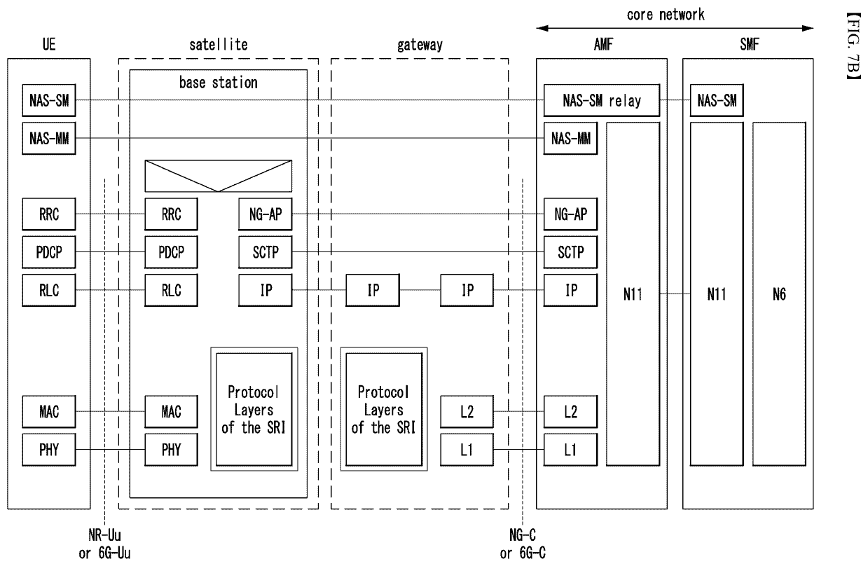

FIG. 7A is a conceptual diagram illustrating a first exemplary embodiment of a protocol stack of a user plane in a regenerative payload-based non-terrestrial network, and FIG. 7B is a conceptual diagram illustrating a first exemplary embodiment of a protocol stack of a control plane in a regenerative payload-based non-terrestrial network.

As shown in FIGS. 7A and 7B, each of user data and control data (e.g. control information) may be transmitted and received through an interface between a UE and a satellite (e.g. base station). The user data may refer to a user protocol data unit (PDU). A protocol stack of a satellite radio interface (SRI) may be used to transmit and receive the user data and/or control data between the satellite and a gateway. The user data may be transmitted and received through a general packet radio service (GPRS) tunneling protocol (GTP)-U tunnel between the satellite and a core network.

Meanwhile, the 95th 3rd Generation Partnership Project (3GPP) radio access network technical plenary, held in March 2022, discussed mobility and service continuity enhancements between a non-terrestrial network (NTN) and a terrestrial network (TN), as well as between NTNs. The main discussion issues may be summarized as follows.
A system information block (SIB) designated for measurement/mobility and service continuity enhancements between NTN and TN, as well as between NTNs, may indicate downlink (DL) and/or uplink (UL) polarization information using parameters for each polarization type, representing a Right-Hand Circular Polarization (RHCP), Left-Hand Circular Polarization (LHCP), or linear polarization.
To enhance cell reselection for earth-moving cells for mobility between NTNs, timing-based and location-based cell reselection for quasi-earth-fixed cells in Release 17 may be considered as a starting point.
Enhancements in handover between NTNs for RRC-connected terminals in quasi-earth-fixed cells and earth-moving cells may reduce signaling overhead.

Meanwhile, the following handover events may exist in terrestrial networks:
Event A1: a case where a measurement value of a serving cell exceeds a threshold.
Event A2: a case where a measurement value of a serving cell is below a threshold.
Event A3: a case where a measurement value of a neighboring cell exceeds a measurement value of a special cell (SpCell) by an offset. Here, the SpCell may be a primary serving cell of one of a master cell group (MCG) or a secondary cell group (SCG).
Event A4: a case where a measurement value of a neighboring cell exceeds a threshold.
Event A5: a case where a measurement value of an SpCell exceeds a first threshold, and a measurement value of a neighboring cell exceeds a second threshold. Event A5 may be a combination of Event A2 and Event A4.
Event A6: a case where a measurement value of a neighboring cell exceeds a measurement value of a secondary cell by an offset.

Meanwhile, a handover procedure in terrestrial networks may be as follows.

FIG. 8 is a sequence chart illustrating a first exemplary embodiment of a handover procedure.

As shown in FIG. 8, a handover procedure may be a conditional handover (CHO) procedure. Cell 1 may be a source cell, and Cell 2 may be a target cell. A measurement procedure between a terminal and Cell 1 may be performed. For example, Cell 1 may transmit measurement configuration information to the terminal. The terminal may perform measurement operations based on the measurement configuration information indicated by Cell 1 and transmit measurement results to Cell 1. Based on the terminal's measurement results, Cell 1 may decide whether to perform a handover procedure (e.g. CHO procedure). If it is decided that a handover procedure is to be performed, Cell 1 may transmit a handover request message to Cell 2 through an Xn interface (S801).

The handover request message may include at least one of bandwidth part (BWP) switching configuration information indicated to the terminal by Cell 1, a BWP switching combination indicated to the terminal by Cell 1, or information on a current BWP (e.g. operating BWP) between the terminal and Cell 1. Cell 2 may receive the handover request message from Cell 1 and identify the information included in the handover request message. Cell 2 may decide whether to approve the handover request (S802). If the handover request is approved, Cell 2 may generate BWP switching configuration information (e.g. BWP switching combination) for Cell 2, considering the BWP switching configuration information of Cell 1.

Cell 2 may transmit a handover response including the BWP switching configuration information (e.g. BWP switching combination) to Cell 1 (S803). Cell 1 may receive the handover response from Cell 2. Upon receiving the handover response, Cell 1 may determine that the handover request has been approved by Cell 2. Cell 1 may generate a handover command message and transmit the handover command message to the terminal (S804). The handover command message may include the BWP switching configuration information of Cell 2. Additionally, the handover command message may include at least a cell information element (IE) and all information required for accessing Cell 2, allowing the terminal to access Cell 2 without reading system information. In some cases, the handover command message may include information required for contention-based and contention-free random access. The terminal may receive the handover command message from Cell 1 and identify the information included in the handover command message (e.g. BWP switching configuration information of Cell 2). The terminal may evaluate a CHO condition and execute the CHO if the CHO condition is satisfied. In this case, the terminal may perform a detach procedure with Cell 1 and a synchronization procedure with Cell 2. When the terminal is connected to Cell 2, the terminal may perform communication with Cell 2. In such a case, the terminal may perform a BWP switching operation based on the BWP switching configuration information included in the received handover command message. Subsequently, the terminal may transmit a handover complete message to Cell 2 (S805). Accordingly, Cell 2 may receive the handover complete message from the terminal.

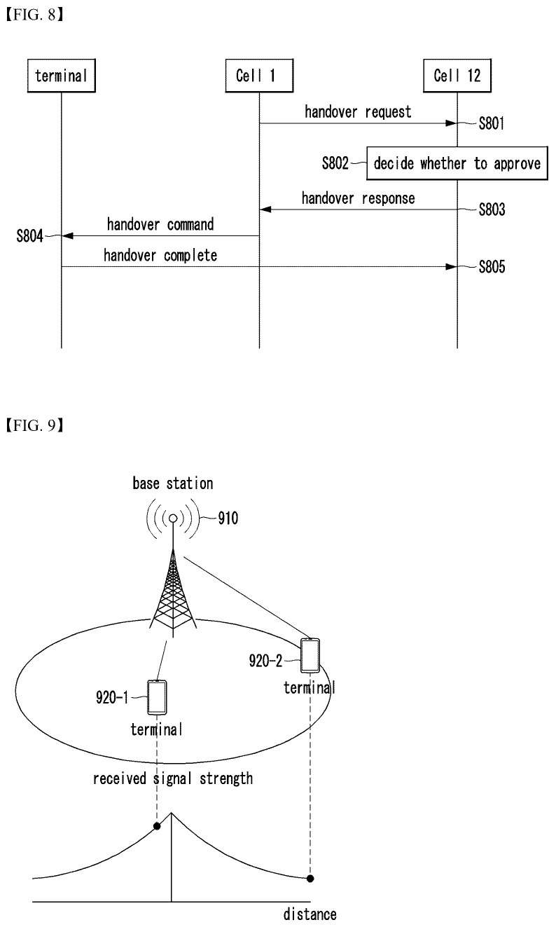

FIG. 9 is a conceptual diagram illustrating a first exemplary embodiment of a change in Reference Signal Received Power (RSRP) according to a distance from a cell center in a terrestrial network.

As shown in FIG. 9, it can be seen that a received signal strength is high for a terminal 920-1 located nearest to a base station 910. Conversely, a received signal strength is low for a terminal 920-2 located farthest from the base station 910. Here, the received signal strength may be, for example, a reference signal received power (RSRP). A difference in RSRP values according to a distance from the base station may be as shown in Table 4. In this case, a path loss exponent is assumed to be 4.

TABLE 4

| | | | | |
|---|---|---|---|---|
| reference | 100 m | 500 m | 1 km | 10 km |

| | | | | | | | | |
|---|---|---|---|---|---|---|---|---|
| 100 | m | 0 dB | −28 | dB | −40 | dB | −80 | dB |
| 500 | m | — | 0 | dB | −12 | dB | −52 | dB |

| | | | | | | | |
|---|---|---|---|---|---|---|---|
| 1 | km | — | — | 0 | dB | −40 | dB |

| | | | | | | |
|---|---|---|---|---|---|---|
| 10 | km | — | — | — | 0 | dB |

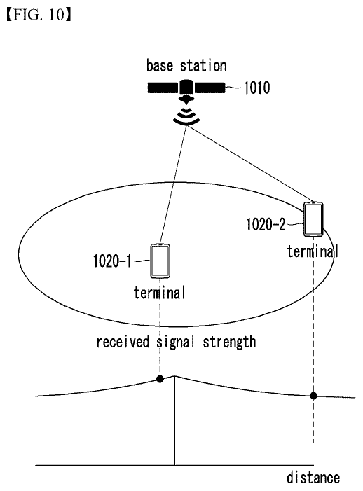

FIG. 10 is a conceptual diagram illustrating a first exemplary embodiment of a change in RSRP according to a distance from a cell center in a non-terrestrial network.

As shown in FIG. 10, it can be seen that a received signal strength is high for a terminal 1020-1 located nearest a base station 1010. Conversely, a received signal strength is low for a terminal 1020-2 located farthest from the base station 1010. However, a difference in received signal strengths may be negligible compared to that observed in terrestrial networks. Here, the received signal strength may be, for example, an RSRP.

The base station 1010 may be located in a Low Earth Orbit (LEO) satellite at an altitude of 600 km. A distance and received signal strength between the satellite and the terminal according a distance of the terminal from a nadir may be as shown in Table 5. In this case, a path loss exponent is assumed to be 2.

TABLE 5

| Nadir-terminal | Satellite-terminal | RSRP at a 10 km | |
|---|---|---|---|
| distance | distance | reference distance | |
| 10 km | 600 km | 0 | dB |
| 50 km | 602 km | 0 | dB |
| 100 km | 608 km | −0.1 | dB |
| 500 km | 781 km | −2.3 | dB |

FIG. 11 is a conceptual diagram illustrating a path difference according to a location of a terminal within a beam coverage.

As shown in FIG. 11, it can be seen that a length of a path from a base station 1110 to a nearby terminal 1120-1 is short. Additionally, it can be seen that a length of a path from the base station 1110 to a distant terminal 1120-2 is long. In this case, if the base station 1110 is located in a satellite providing services using multi-beams, a cell radius of approximately 50 km may result in a negligible path length difference. A delay from the base station 1110 to the nearest terminal 1120-1 may be a nadir delay. Furthermore, a delay from the base station 1110 to the distant terminal 1120-2 may be calculated by adding a delay difference to the nadir delay. Consequently, a distance between the satellite and a terminal located 500 km from the nadir may be only 781 km, which corresponds to an RSRP difference of −2.3 dB compared to a terminal located at a 10 km reference distance. Although there is a difference in path length within the beam coverage, it may not exhibit variations observed in terrestrial networks.

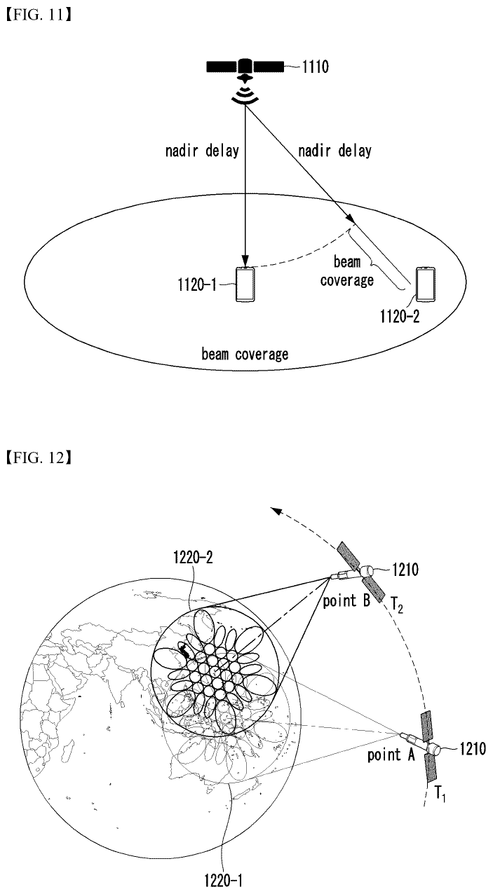

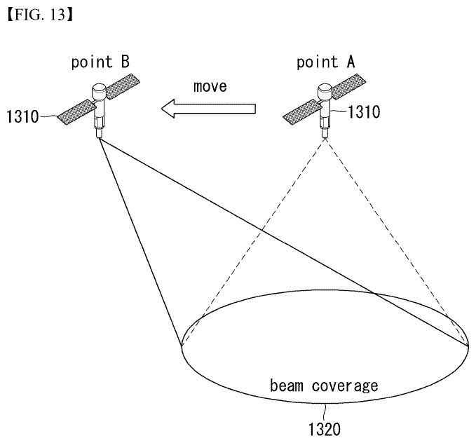

FIG. 12 is a conceptual diagram illustrating a first exemplary embodiment of a change in an earth-moving beam coverage in a multi-beam environment.

As shown in FIG. 12, a satellite may be moving along its orbit. Accordingly, a satellite 1210 may be at a point A at time T₁ and have a first cell coverage 1220-1 on the ground. Furthermore, the satellite 1210 may be at a point B at time T₂ and have a second cell coverage 1220-2 on the ground. The cell coverage on the ground may continuously change according to the movement of the satellite 1210.

In this case, a remaining service time in a cell may be referred to as a remaining cell expire time. Such remaining time may vary depending on a location of a terminal. Additionally, the remaining time for each terminal may vary according to the movement of the satellite. Then, the terminal may leave a coverage of a currently serviced cell. In such cases, the terminal may perform a handover to another cell.

FIG. 13 is a conceptual diagram illustrating a first exemplary embodiment of a change in an earth-fixed beam coverage in a multi-beam environment.

As shown in FIG. 13, a satellite may be moving along its orbit. Accordingly, a satellite 1310 may be at a point A at time T₁ and have a cell coverage 1320 on the ground. Additionally, the satellite 1310 may be at a point B at time T₂, and in such cases, the satellite 1310 may maintain the same cell coverage 1320 on the ground. As such, the ground cell coverage 1320 may remain unchanged despite the movement of the satellite 1310. In this case, a remaining service time in a cell may be referred to as a remaining cell expire time. Such remaining time may be equal to the remaining service time of the satellite 1310.

Meanwhile, in TNs, a handover may be performed based on measured RSRP values reported by a terminal. However, in NTN environments, RSRP differences may not be significant depending on the location of the terminal within a cell due to the high altitude of the satellite. Particularly, in case of a multi-beam-based satellite, the RSRP difference between a center and edge of a cell may be even smaller due to the relatively small cell size. Therefore, in NTN environments, handover methods may consider additional factors such as timers and ephemeris information along with RSRP measurements. Various handover methods may be proposed by taking into account such factors. Furthermore, handover methods between NTN and TN may also be required. Accordingly, the 3GPP is discussing handover methods between NTN and TN.

The handover between NTN and TN may be a handover between heterogeneous networks with different characteristics. Such a handover method may include a handover method from TN to NTN and a handover method from NTN to TN. This handover method may need to operate efficiently under various situations of NTN and TN. To achieve this, the handover method may require aspects such as measurement triggering for handover, measurement complexity, signaling based on reporting of measurement values, and methods for determining a handover timing.

The methods proposed in the present disclosure may consider various handover scenarios between TN and NTN. Handover situations between TN and NTN may arise in various combinations of the following conditions.
One condition may be whether a satellite beam is an Earth-moving beam (EMB).
One condition may be whether a satellite beam is an Earth-fixed beam (EFB).
One condition may be whether a handover point is the boundary of TN service coverage.
One condition may be whether a handover point is a hole in TN service coverage.
One condition may be whether a handover is from TN to NTN.
One condition may be whether a handover is from NTN to TN.
One condition may be whether a handover is caused by the terminal's movement.
One condition may be whether a handover is caused by the satellite's movement.

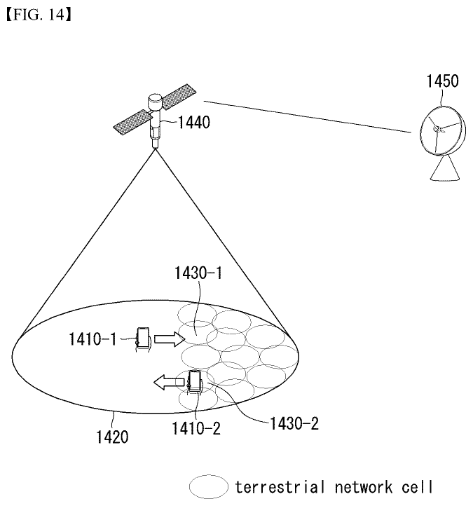

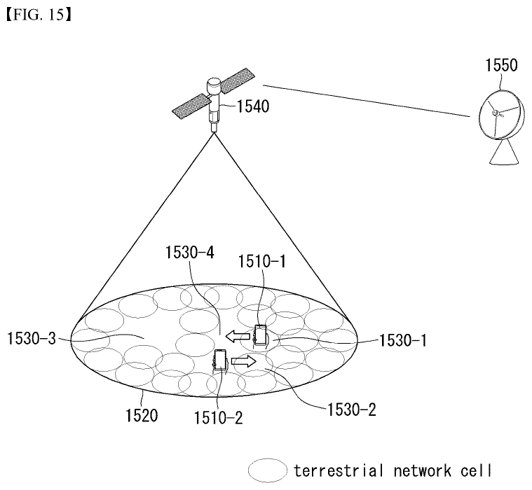

FIG. 14 is a conceptual diagram illustrating a first exemplary embodiment of a handover scenario.

As shown in FIG. 14, terminals 1410-1 and 1410-2 may move at a boundary of TN service coverages 1430-1 and 1430-2. For example, the first terminal 1410-1 may move from a service coverage 1420 of an NTN serviced by a satellite 1440 to a service coverage 1430-1 of a TN. When the first terminal 1410-1 moves from the service coverage 1420 of the NTN to the service coverage 1430-1 of the TN, a handover from NTN to TN may occur. Conversely, the second terminal 1410-2 may move from the service coverage 1430-2 of the TN to the service coverage 1420 of the NTN. When the second terminal 1410-2 moves from the service coverage 1430-2 of the TN to the service coverage 1420 of the NTN, a handover from TN to NTN may occur. Such a handover may occur regardless of whether the satellite beam is an EFB or EMB.

Here, each of the terminals 1410-1 and 1410-2 may be a pedestrian, vehicle, or high-speed train on the ground and, in a broader sense, may be an airplane, personal air vehicle (PAV), or drone. The bent-pipe satellite 1440 may be connected to a gateway 1450. The bent-pipe satellite 1440 may form a relatively large NTN cell. In contrast, TN cells may have small service coverages. Such TN cells may have boundaries due to various factors such as sea, rivers, deserts, or forests.

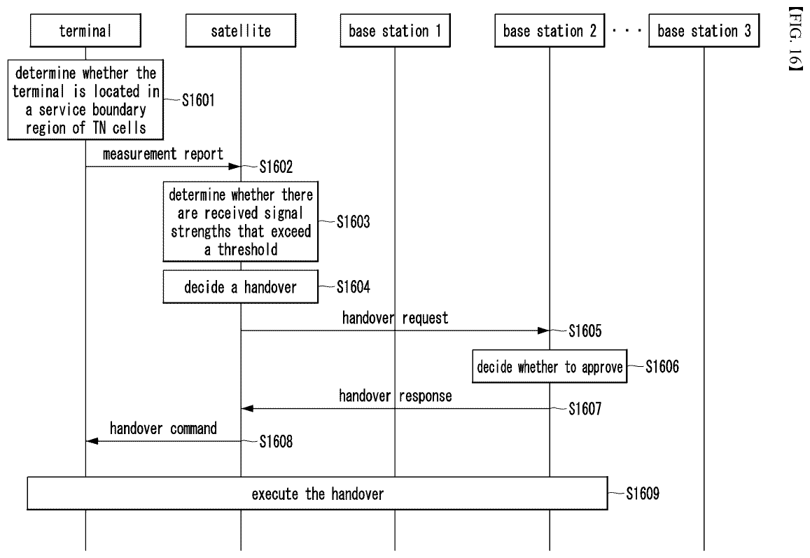

FIG. 15 is a conceptual diagram illustrating a second exemplary embodiment of a handover scenario.

As shown in FIG. 15, terminals 1510-1 and 1510-2 may move at a boundary of TN service coverages 1530-1 and 1530-2. In this case, the TN service coverages 1530-1 and 1530-2 may form holes 1530-3 and 1530-4. Under such conditions, as an example, the first terminal 1510-1 may move from the TN service coverage 1530-1 to an NTN service coverage 1520 of a satellite 1540. When the first terminal 1510-1 moves from the TN service coverage 1530-1 to the NTN service coverage 1520, a handover from TN to NTN may occur. Conversely, the second terminal 1510-2 may move from the NTN service coverage 1520 to the TN service coverage 1530-2. When the second terminal 1510-2 moves from the NTN service coverage 1520 to the TN service coverage 1530-2, a handover from NTN to TN may occur. Such handovers may occur regardless of whether the satellite beam is an EFB or EMB.

Here, each of the terminals 1510-1 and 1510-2 may be a pedestrian, vehicle, or high-speed train on the ground and, in a broader sense, may be an airplane, PAV, or drone. The bent-pipe satellite 1540 may be connected to a gateway 1550. The bent-pipe satellite 1540 may form a relatively large NTN cell. In contrast, TN cells may have small service coverages.

Meanwhile, RSRP values of signals received at the terminal from the NTN satellite may be sufficiently high. In such situations, the terminal may be handed over to a TN cell. In this case, RSRP values of signals received from TN cells may vary significantly depending on distances between TN base stations and the terminal. However, the RSRP values of signals received at the terminal from the NTN satellite may not vary significantly within the same NTN cell coverage.

As described above, the RSRP values of signals received at the terminal from the NTN satellite may not be poor. Therefore, an A2 event condition may not be satisfied. Additionally, the RSRP values of signals received from the TN cell may vary significantly depending on a location within the TN cell. Consequently, an A3 event condition may not be suitable for a handover from NTN to TN.

Under such conditions, the terminal may perform a handover between NTN and TN based solely on the RSRP values of signals received from the TN and NTN cells. In this case, a handover may be triggered after the terminal reaches near a base station of the TN cell. Additionally, the terminal may be handed over to the NTN cell at the boundary of the TN cell.

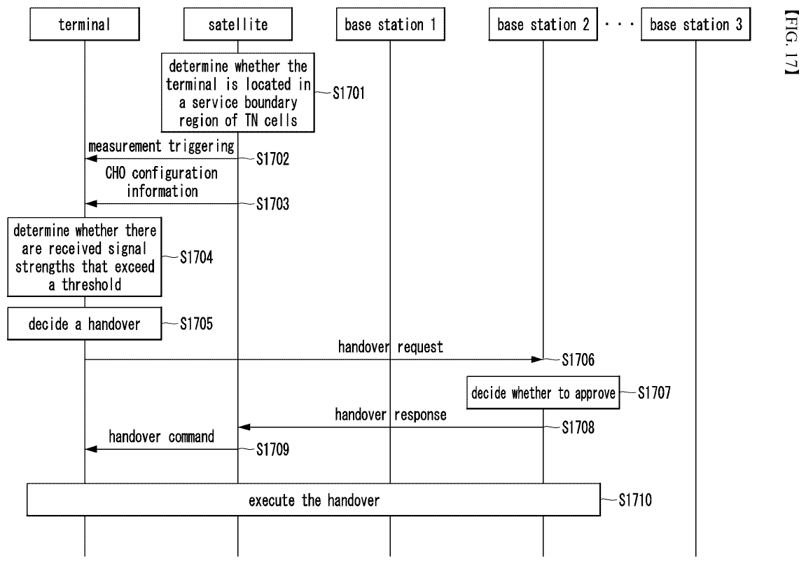

FIG. 16 is a sequence chart illustrating a first exemplary embodiment of a handover method between NTN and TN.

As shown in FIG. 16, in a handover method between NTN and TN, a satellite (i.e. non-terrestrial base station) may provide a terminal with information on boundary regions of TN cells serviced by base stations located on the ground (i.e. terrestrial base stations), location information of the base stations, cell radius information of the base stations, and ephemeris information. Here, the information on the boundary regions of TN cells may include location information of the boundary regions of TN cells. Accordingly, the terminal may receive, from the satellite, information on the boundary regions of TN cells serviced by the base stations on the ground, location information of the base stations, cell radius information of the base stations, and ephemeris information. In this case, the terminal may be located in an NTN cell provided by the satellite.

Meanwhile, the terminal may receive GPS signals from global navigation satellite system (GNSS) satellites to determine a location of the terminal. The terminal may determine whether the terminal is located in a service boundary region of TN cells, based on the determined location of the terminal and the location information of the boundary regions of TN cells (S1601). If the terminal determines that the terminal is located in a service boundary region of TN cells, the terminal may initiate measurements for TN cells. In other words, the terminal may receive signals from terrestrial base stations and measure received signal strengths. Here, the received signal strength may be RSRP. Thus, the terminal located in the NTN cell may initiate measurement on TN cells when the terminal is determined to approach a service boundary region of TN cells based on the location of the terminal.

Here, the terminal may further consider the location information of the base stations, cell radius information of the base stations, and ephemeris information to initiation measurements on TN cells. Additionally, the terminal may adaptively set a triggering time for TN cell measurements based on a distance between the terminal's location and the service boundary region of TN cells, as well as a speed and direction of the terminal's movement. In this case, the movement speed and direction of the terminal may be calculated based on average values over a specific period of time. Parameters related to the movement speed and direction of the terminal may be predefined or signaled from the satellite to the terminal. Meanwhile, the terminal may adaptively set a measurement periodicity for TN cells based on the distance between the terminal's location and the service boundary region of TN cells, as well as the terminal's movement speed and direction. In such cases, the movement speed and direction of the terminal may be calculated based on average values over a specific period of time. The parameters related to the movement speed and direction of the terminal may be predefined or signaled from the satellite to the terminal.

Then, the terminal may transmit information on the measured received signal strengths for signals received from the base stations to the satellite, thereby performing measurement reporting (S1602). The base station may then determine whether there are received signal strengths exceeding a threshold among the received signal strengths reported by the terminal (S1603). If the base station determines that there are received signal strengths exceeding the threshold, the base station may decide a handover of the terminal to a base station corresponding to the highest received signal strength (S1604). For example, the base station corresponding to the highest received signal strength may be a base station 2. If RSRP value(s) of at least one TN cell are greater than the threshold, the base station may initiate a handover to the corresponding TN cell.

If it is decided that a handover procedure is to be performed, the satellite may transmit a handover request message to the base station 2 through an Xn interface (S1605). The handover request message may include at least one of BWP switching configuration information indicated to the terminal by the satellite, a BWP switching combination indicated to the terminal by the satellite, or information on a current BWP (e.g. active BWP) between the terminal and the satellite. The base station 2 may receive the handover request message from the satellite and identify the information included in the handover request message. The base station 2 may decide whether to approve the handover request (S1606). If the handover request is approved, the base station 2 may generate BWP switching configuration information (e.g. BWP switching combination) for the base station 2, considering the BWP switching configuration information of the satellite.

The base station 2 may transmit a handover response including the BWP switching configuration information (e.g. BWP switching combination) to the satellite (S1607). The satellite may receive the handover response from the base station 2. Upon receiving the handover response, the satellite may determine that the handover request to the base station 2 has been approved. The satellite may generate a handover command message and transmit the handover command message to the terminal (S1608). The handover command message may include the BWP switching configuration information for the base station 2. Additionally, the handover command message may include at least a cell information element (IE) and all information required for accessing the base station 2, allowing the terminal to access the base station 2 without reading system information. Depending on a situation, the handover command message may also include information required for contention-based and contention-free random access.

The terminal may receive the handover command message from the satellite and identify the information included in the handover command message (e.g. BWP switching configuration information of the base station 2). The terminal may evaluate a CHO condition and execute the CHO if the CHO condition is satisfied (S1609). In this case, the terminal may perform a detach procedure with the satellite and a synchronization procedure with the base station 2. When the terminal is connected to the base station 2, the terminal may perform communication with the base station 2. In such a case, the terminal may perform a BWP switching operation based on the BWP switching configuration information included in the received handover command message. Subsequently, the terminal may transmit a handover complete message to the base station 2. Accordingly, the base station 2 may receive the handover complete message from the terminal.

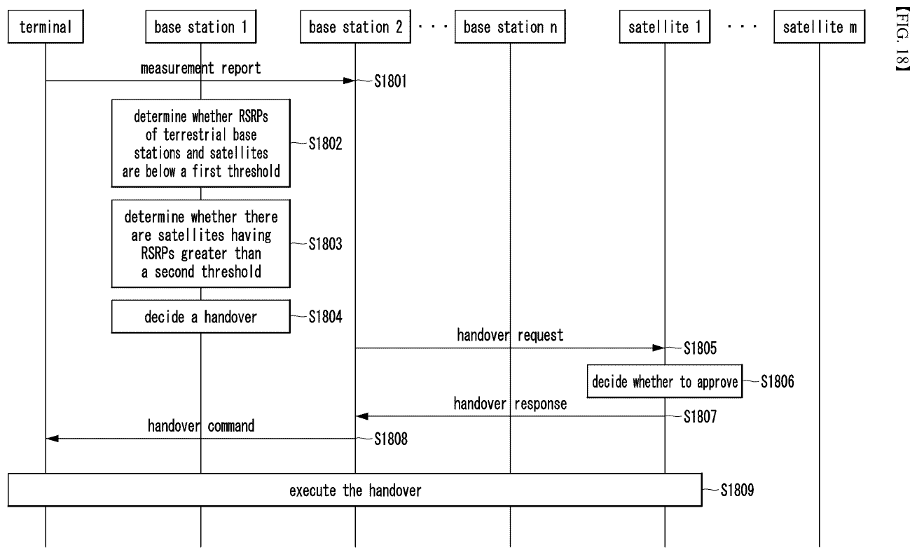

FIG. 17 is a sequence chart illustrating a second exemplary embodiment of a handover method between NTN and TN.

As shown in FIG. 17, in a handover method between NTN and TN, base stations (i.e. terrestrial base stations) may transmit information on boundary regions of TN cells serviced by the base stations to a satellite (i.e. non-terrestrial base station). Then, the satellite may receive the information on the boundary regions of TN cells served by the base stations from the base stations on the ground. Here, the information on the boundary regions of TN cells may include location information of the boundary regions of the TN cells.

Meanwhile, a terminal may determine its location by receiving GPS signals from GNSS satellites. Additionally, the terminal may transmit information on its determined location to the satellite. Then, the satellite may determine the terminal's location by receiving the information on the terminal's location from the terminal. Here, the base station may determine the terminal's location by receiving the location information from the terminal, but the present disclosure is not limited thereto, and may determine the location through various other methods.

Meanwhile, the satellite may determine whether the terminal is located in a boundary region of a TN cell based on the determined location of the terminal and the location information of boundary regions of TN cells (S1701). If the satellite determines that the terminal is located in a service boundary region of TN cells, the terminal may transmit a terrestrial cell measurement triggering signal to the terminal to allow the terminal to initiate measurements on TN cells (S1702).

The terminal may receive the terrestrial cell measurement triggering signal from the satellite. Meanwhile, the satellite may transmit conditional handover (CHO) configuration information to the terminal to enable the terminal to perform a CHO (S1703). Then, the terminal may receive the CHO configuration information from the satellite. The CHO configuration information may include information on thresholds and information on the base stations located on the ground. Here, the information on the base stations may include physical cell identifiers (PCIs) or the like. Considering the CHO method as described above, handover decision may be made by the terminal. In this case, the terminal may receive related information in advance from the satellite through signaling.

Subsequently, the terminal may receive signals from the base stations located on the ground and measure received signal strengths. Here, the received signal strengths may be RSRPs. The terminal may determine whether there are received signal strengths exceeding a threshold among the measured received signal strengths (S1704). If the terminal determines that there are received signal strengths exceeding the threshold, the terminal may decide to perform a handover to a base station corresponding to the highest received signal strength (S1705). For example, the base station corresponding to the highest received signal strength may be the base station 2.

If it is decided that a handover procedure is to be performed, the terminal may transmit a handover request message to the base station 2 (S1706). The handover request message may include at least one of BWP switching configuration information indicated to the terminal by the satellite, a BWP switching combination indicated to the terminal by the satellite, or information on a current BWP (e.g. operating BWP) between the terminal and the satellite. The base station 2 may receive the handover request message from the terminal and identify the information included in the handover request message. The base station 2 may decide whether to approve the handover request (S1707). If the handover request is approved, the base station 2 may generate BWP switching configuration information (e.g. BWP switching combination) for the base station 2, considering the BWP switching configuration information of the satellite.

The base station 2 may transmit a handover response including the BWP switching configuration information (e.g. BWP switching combination) to the satellite (S1708). The satellite may receive the handover response from the base station 2. Upon receiving the handover response, the satellite may determine that the handover request has been approved by the base station 2. The satellite may generate a handover command message and transmit the handover command message to the terminal (S1709). The handover command message may include the BWP switching configuration information of the base station 2.

Additionally, the handover command message may include at least a cell information element (IE) and all information required to access the base station 2, allowing the terminal to access the base station 2 without reading system information. Depending on a situation, information required for contention-based and contention-free random access may be included in the handover command message. The terminal may receive the handover command message from the satellite and identify the information included in the handover command message (e.g. BWP switching configuration information of the base station 2).

The terminal may execute the CHO (S1710). In this case, the terminal may perform a detach procedure with the satellite and a synchronization procedure with the base station 2. When the terminal is connected to the base station 2, the terminal may perform communication with the base station 2. In such a case, the terminal may perform a BWP switching operation based on the BWP switching configuration information included in the received handover command message. Subsequently, the terminal may transmit a handover complete message to the base station 2. Accordingly, the base station 2 may receive the handover complete message from the terminal. Here, although the satellite has been described as determining whether the terminal has approached the service boundary region of TN cells, the terminal may independently determine whether the terminal has approached the service boundary region of TN cells. When the terminal determines that itself has approached the service boundary region of TN cells, the terminal may receive signals from the base stations on the ground and measure received signal strengths. The terminal, satellite, and base station 2 may then perform subsequent procedures (S1704 to S1710).

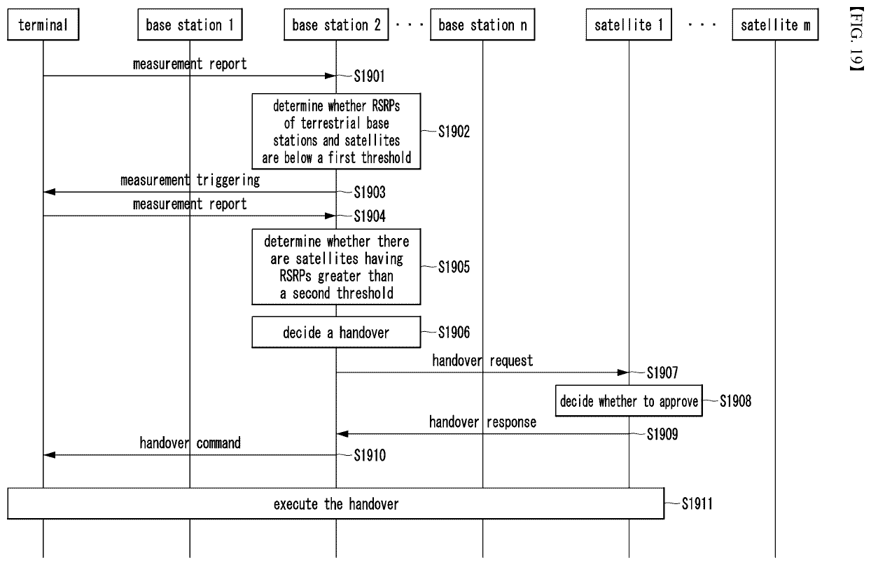

Meanwhile, the present disclosure describes methods for handover from TN to NTN due to movement of the terminal with reference to FIGS. 18 to 21. The handover methods in FIGS. 18 to 21 may require determining whether the terminal in an NTN cell has approached the service boundary region of TN cells.

The base station may determine whether the terminal has approached the service boundary region of TN cells based on the location of the terminal, location of a base station serving the terminal, ID of the base station, and information on a TN service coverage. In this case, the base station may acquire information required for the determination by receiving the information from the terminal.

Alternatively, the terminal may determine whether it has approached the service boundary region of TN cells based on the location of the terminal, the location of the base station serving the terminal, the ID of the base station, and information on the TN service coverage. In this case, the terminal may acquire information required for the determination by receiving the information from the base station throughs signaling.

In FIG. 14, the second terminal 1410-2 may be handed over from TN to NTN due to its movement. The present disclosure proposes three methods for handover of a terminal from TN to NTN. In this case, the three methods may use a first threshold and a second threshold. The first threshold and the second threshold may be pre-defined for the terminal, satellite, and terrestrial base station(s). Alternatively, the first threshold and the second threshold may be signaled to the terminal, satellite, and terrestrial base station(s) through system information.

If signals of the serving cell are sufficiently low, and signals of a neighboring cell are sufficiently high, a ping-pong effect during the handover process may be prevented. Therefore, the first threshold may be smaller than the second threshold. However, given that a delay in the NTN cell is significantly greater than in the TN cell and depending on the user's preference for NTN and TN services, the first threshold and the second threshold may be set differently.

### (Method 1)

In Method 1, the terminal may periodically measure RSRPs of the serving TN cell, neighboring TN cell, and NTN cell. A handover may be executed when the RSRPs of both the serving TN cell and the neighboring TN cell are smaller than the first threshold, and the RSRP of the NTN cell is greater than the second threshold.

### (Method 2)

In Method 2, when the RSRPs of both the serving TN cell and the neighboring TN cell are smaller than the first threshold, the terminal may initiate measurement of the RSRP of the NTN cell. A handover may be executed when the RSRP of the NTN cell is greater than the second threshold.

### (Method 3)

The terminal may be located at a service boundary region of TN cells.

(Method 3-1) Method 3-1 may be similar to Method 1.
(Method 3-2) Method 3-2 may be similar to Method 2.
(Method 3-3) In Method 3-3, the terminal may measure the RSRP of the NTN cell without measuring the RSRP of the TN cell.

Among Methods 1 to 3, Method 1 may impose the highest RSRP measurement load on the terminal. However, a time required to determine whether the handover condition is satisfied may be shortest in Method 1. In Method 2, the terminal may perform the RSRP measurement on the NTN cell based on the RSRP measurement on the TN cell. Therefore, the RSRP measurement load for the NTN cell in Method 2 may be reduced compared to Method 1. However, in Method 2, an additional delay may occur as the RSRP measurement on the NTN cell is initiated based on the RSRP measurement on the TN cell. Furthermore, Method 2 may represent an approach where the measurement on the NTN cell is initiated only after a signal quality received from all serving TN cells and neighboring TN cells deteriorates. Due to this late handover trigger, signal quality degradation may occur in Method 2. The first threshold and the second threshold in Method 2 may be set differently from the first threshold and the second threshold in Method 1.

For example, in Method 2, the first threshold may be set to a value greater than the first threshold in Method 1. As a result, the terminal may perform measurements on the NTN cell earlier. Methods 3-1 to 3-3 may reduce measurement overhead and handover delay by initiating the measurement of the RSRP of the NTN cell when the TN cell is located at a service boundary region of TN cells. Additionally, the threshold Th1-s for the RSRP of the serving TN cell and the threshold Th1-n for the RSRP of the neighboring TN cell may not be set to the same value as the first threshold. In other words, the values of Th1-s and Th1-n may differ. For example, the value of Th1-s may be set smaller than the value of Th1-n.

FIG. 18 is a sequence chart illustrating a third exemplary embodiment of a handover method between NTN and TN.

As shown in FIG. 18, in a handover method between NTN and TN, a terminal may be located within a service coverage of a terrestrial base station 2 and receive services from the base station 2. In such a situation, the terminal may measure received signal strengths for terrestrial base stations (base stations 1 to base station n) and satellites (satellites 1 to satellite m) around the base station 2. Here, n and m may be positive integers. The terminal may then transmit the measured received signal strengths for the terrestrial base stations and satellites around the base station 2 to the base station 2 through a measurement report (S1801). The base station 2 may receive the information on the received signal strengths of the neighboring terrestrial base stations and satellites from the terminal. Here, the received signal strength may be RSRP.

Subsequently, the base station 2 may determine whether the received signal strengths (i.e. RSRPs) of the neighboring terrestrial base stations received from the terminal are below the first threshold (S1802). If the base station 2 determines that the received signal strengths of the neighboring terrestrial base stations are below the first threshold, the base station 2 may then determine whether there are received signal strengths (i.e., RSRPs) of satellites that exceed the second threshold (S1803). If the base station 2 determines that there are received signal strengths exceeding the second threshold, the base station 2 may decide to perform a handover to a satellite corresponding to the highest received signal strength (S1804). For example, the satellite corresponding to the highest received signal strength may be the satellite 1.

If it is decided that a handover procedure is to be performed, the base station 2 may transmit a handover request message to the satellite 1 (S1805). The handover request message may include at least one of BWP switching configuration information indicated to the terminal by the base station 2, a BWP switching combination indicated to the terminal by the base station 2, or information on a current BWP (e.g. operating BWP) between the terminal and the base station 2. The satellite 1 may receive the handover request message from the base station 2 and identify the information included in the handover request message. The satellite 1 may decide whether to approve the handover request (S1806). If the handover request is approved, the satellite 1 may generate BWP switching configuration information (e.g. BWP switching combination) for the satellite 1, considering the BWP switching configuration information of the base station 2.

The satellite 1 may transmit a handover response including the BWP switching configuration information (e.g. BWP switching combination) to the base station 2 (S1807). The base station 2 may receive the handover response from the satellite 1. Upon receiving the handover response, the base station 2 may determine that the handover request has been approved by the satellite 1. The base station 2 may generate a handover command message and transmit the handover command message to the terminal (S1808). The handover command message may include the BWP switching configuration information of the satellite 1. Additionally, the handover command message may include at least a cell information element (IE) and all information required to access the satellite 1, allowing the terminal to access the satellite 1 without reading system information. Depending on a situation, the handover command message may include information required for contention-based and contention-free random access. The terminal may receive the handover command message from the base station 2 and identify the information included in the handover command message (e.g. BWP switching configuration information of the satellite 1). The terminal may execute the CHO (S1809). In this case, the terminal may perform a detach procedure with the base station 2 and a synchronization procedure with the satellite 1. When the terminal is connected to the satellite 1, the terminal may perform communication with the satellite 1. In such a case, the terminal may perform a BWP switching operation based on the BWP switching configuration information included in the received handover command message. Subsequently, the terminal may transmit a handover complete message to the satellite 1. Accordingly, the satellite 1 may receive the handover complete message from the terminal. Here, the first threshold may be greater than the second threshold. As described with reference to FIG. 18, the handover method between NTN and TN may correspond to Method 1 described earlier.

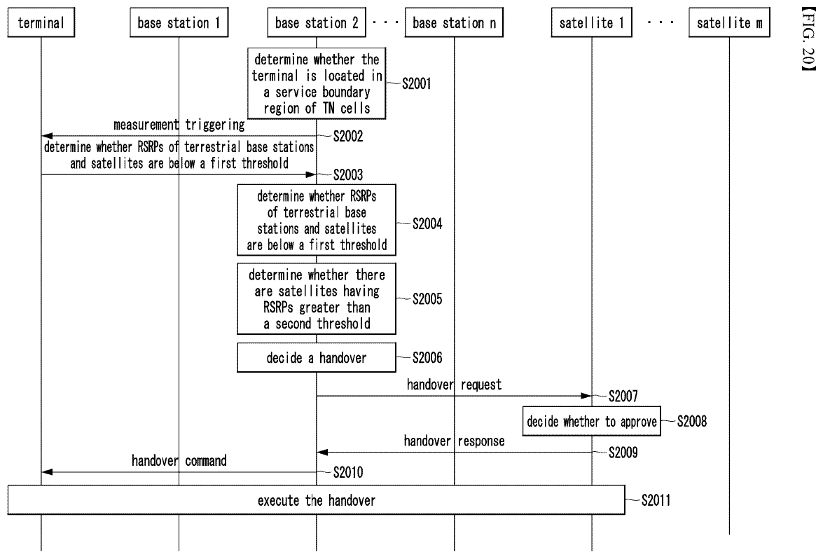

FIG. 19 is a sequence chart illustrating a fourth exemplary embodiment of a handover method between NTN and TN.

As shown in FIG. 19, in a handover method between NTN and TN, the terminal may be located within a service coverage of the terrestrial base station 2 and receive services from the base station 2. In this situation, the terminal may measure received signal strengths for terrestrial base stations (base stations 1 to base station n) around the base station 2. Here, n may be a positive integer. The terminal may then transmit the measured received signal strengths for the terrestrial base stations around the base station 2 to the base station 2 through a measurement report (S1901). The base station 2 may receive the information on the received signal strengths of the neighboring terrestrial base stations from the terminal. Here, the received signal strength may be RSRP.

Subsequently, the base station 2 may determine whether the received signal strengths (i.e. RSRPs) of the neighboring terrestrial base stations received from the terminal are below the first threshold (S1902). If the base station 2 determines that the received signal strengths of the neighboring terrestrial base stations are below the first threshold, the base station 2 may transmit a measurement triggering signal to the terminal, instructing the terminal to perform measurements on satellites (S1903). The terminal may then receive the measurement triggering signal from the base station 2.

In such a situation, the terminal may measure received signal strengths for the satellites (satellites 1 to satellite m) around the base station 2. Here, m may be a positive integer. The terminal may then transmit the measured received signal strengths for the satellites around the base station 2 to the base station 2 through a measurement report (S1904). The base station 2 may receive the information on the received signal strengths of the neighboring satellites from the terminal. Here, the received signal strength may be RSRP.

Subsequently, the base station 2 may determine whether there are received signal strengths (i.e. RSRPs) of the neighboring satellites received from the terminal that exceed the second threshold (S1905). If the base station 2 determines that there are received signal strengths exceeding the second threshold, the base station 2 may decide to perform a handover to a satellite corresponding to the highest received signal strength (S1906). For example, the satellite corresponding to the highest received signal strength may be the satellite 1.

If it is decided that the handover procedure is to be performed, the base station 2 may transmit a handover request message to the satellite 1 (S1907). The handover request message may include at least one of BWP switching configuration information indicated to the terminal by the base station 2, a BWP switching combination indicated to the terminal by the base station 2, or information on a current BWP (e.g. operating BWP) between the terminal and the base station 2. The satellite 1 may receive the handover request message from the base station 2 and identify the information included in the handover request message. The satellite 1 may decide whether to approve the handover request (S1908). If the handover request is approved, the satellite 1 may generate BWP switching configuration information (e.g. BWP switching combination) for the satellite 1, considering the BWP switching configuration information of the base station 2.

The satellite 1 may transmit a handover response including the BWP switching configuration information (e.g. BWP switching combination) to the base station 2 (S1909). The base station 2 may receive the handover response from the satellite 1. Upon receiving the handover response, the base station 2 may determine that the handover request has been approved by the satellite 1. The base station 2 may generate a handover command message and transmit the handover command message to the terminal (S1910). The handover command message may include the BWP switching configuration information of the satellite 1. Additionally, the handover command message may include at least a cell information element (IE) and all information required to access the satellite 1, allowing the terminal to access the satellite 1 without reading system information. Depending on a situation, the handover command message may include information required for contention-based and contention-free random access.

The terminal may receive the handover command message from the base station 2 and identify the information included in the handover command message (e.g. BWP switching configuration information of the satellite 1). The terminal may execute the CHO (S1911). In this case, the terminal may perform a detach procedure with the base station 2 and a synchronization procedure with the satellite 1. When the terminal is connected to the satellite 1, the terminal may perform communication with the satellite 1.

In such a case, the terminal may perform a BWP switching operation based on the BWP switching configuration information included in the received handover command message. Subsequently, the terminal may transmit a handover complete message to the satellite 1. Accordingly, the satellite 1 may receive the handover complete message from the terminal. Here, the first threshold may be greater than the second threshold. As described with reference to FIG. 19, the handover method between NTN and TN may correspond to Method 2 described earlier.

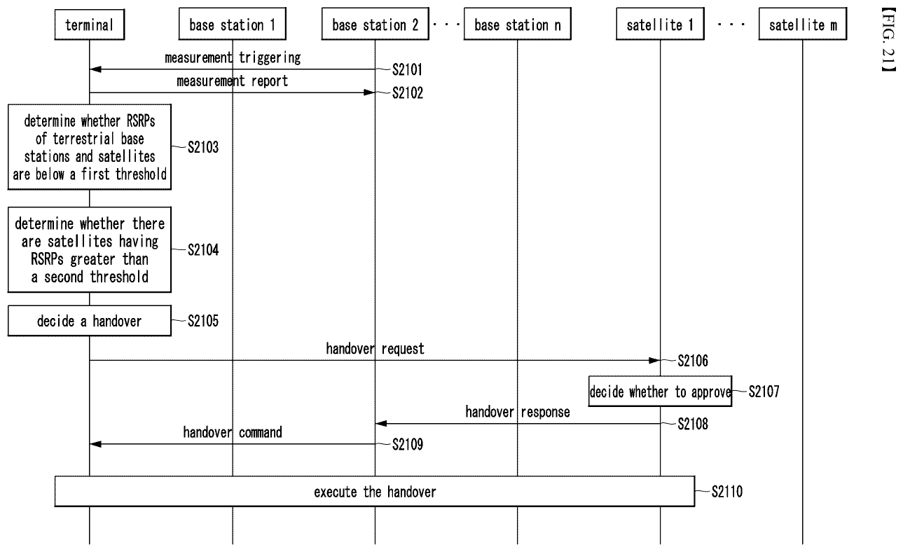

FIG. 20 is a sequence chart illustrating a fifth exemplary embodiment of a handover method between NTN and TN.

As shown in FIG. 20, in a handover method between NTN and TN, information on boundary regions of TN cells serviced by base stations (i.e. terrestrial base stations) may be shared among the base stations. Here, the information on the boundary regions of TN cells may include location information of the boundary regions of TN cells.

Meanwhile, the terminal may receive GPS signals from GNSS satellites to determine the location of the terminal. The terminal may then transmit information on the determined location to the base station providing services (e.g. base station 2). The base station 2 may receive the location information from the terminal and determine the location of the terminal. Here, the base station 2 may determine the location of the terminal by receiving the location information from the terminal, but it is not limited to this method and may use other methods to determine the location.

Meanwhile, the base station 2 may determine whether the terminal is located in a boundary region of TN cells based on the determined terminal's location and the location information of the boundary regions of TN cells (S2001). If the base station 2 determines that the terminal is located in a boundary region of TN cells, the base station 2 may transmit a measurement triggering signal to the terminal, instructing the terminal to initiate measurements on the TN cells and the NTN cell (S2002).

In such a situation, the terminal may measure received signal strengths for terrestrial base stations (base stations 1 to base station n) and satellites (satellites 1 to satellite m) around the base station 2. Here, n and m may be positive integers. The terminal may then transmit the measured received signal strengths for the terrestrial base stations and satellites around the base station 2 to the base station 2 through a measurement report (S2003). The base station 2 may receive the information on the received signal strengths of the neighboring terrestrial base stations and satellites from the terminal. Here, the received signal strength may be RSRP.

Subsequently, the base station 2 may determine whether the received signal strengths (i.e. RSRPs) of the neighboring terrestrial base stations received from the terminal are below the first threshold (S2004). If the base station 2 determines that the received signal strengths of the neighboring terrestrial base stations are below the first threshold, the base station 2 may then determine whether there are received signal strengths (i.e. RSRPs) of the satellites that exceed the second threshold (S2005). If the base station 2 determines that there are received signal strengths exceeding the second threshold, the base station 2 may decide to perform a handover to a satellite corresponding to the highest received signal strength (S2006). For example, the satellite corresponding to the highest received signal strength may be the satellite 1.

If it is decided that a handover procedure is to be performed, the base station 2 may transmit a handover request message to satellite 1 (S2007). The handover request message may include at least one of BWP switching configuration information indicated to the terminal by the base station 2, a BWP switching combination indicated to the terminal by the base station 2, or information on a current BWP (e.g. operating BWP) between the terminal and the base station 2. The satellite 1 may receive the handover request message from the base station 2 and identify the information included in the handover request message. The satellite 1 may decide whether to approve the handover request (S2008). If the handover request is approved, the satellite 1 may generate BWP switching configuration information (e.g. BWP switching combination) for the satellite 1, considering the BWP switching configuration information of the base station 2.

The satellite 1 may transmit a handover response including the BWP switching configuration information (e.g. BWP switching combination) to the base station 2 (S2009). The base station 2 may receive the handover response from the satellite 1. Upon receiving the handover response, the base station 2 may determine that the handover request has been approved by the satellite 1. The base station 2 may generate a handover command message and transmit the handover command message to the terminal (S2010). The handover command message may include the BWP switching configuration information of the satellite 1. Additionally, the handover command message may include at least a cell information element (IE) and all information required to access the satellite 1, allowing the terminal to access the satellite 1 without reading system information. Depending on a situation, the handover command message may include information required for contention-based and contention-free random access. The terminal may receive the handover command message from the base station 2 and identify the information included in the handover command message (e.g. BWP switching configuration information of the satellite 1).

The terminal may execute the CHO (S2011). In this case, the terminal may perform a detach procedure with the base station 2 and a synchronization procedure with the satellite 1. When the terminal is connected to the satellite 1, the terminal may perform communication with the satellite 1. In such a case, the terminal may perform a BWP switching operation based on the BWP switching configuration information included in the received handover command message. Subsequently, the terminal may transmit a handover complete message to the satellite 1. Accordingly, the satellite 1 may receive the handover completion message from the terminal. Here, the first threshold may be greater than the second threshold. The handover method between NTN and TN described with reference to FIG. 20 may corresponds to Method 3-1 described earlier.

Meanwhile, a handover from TN to NTN due to the terminal's movement may be performed based on CHO. In such a case, the procedures of FIG. 18 corresponding to Method 1 may be modified as shown in FIG. 21. In a conditional handover, handover decision may be made by the terminal. For this purpose, the terminal may receive related information in advance from the serving base station through signaling. Compared to FIG. 18, in FIG. 21, the terminal may initiate measurements on the NTN cell based on a measurement triggering event for the NTN cell. The terminal may also receive CHO configuration information from the base station. The CHO configuration information may include information on thresholds and ephemeris information. The terminal may decide to perform a handover when the RSRP of the serving TN cell and the neighboring TN cell is below the first threshold, and the RSRP of the NTN cell exceeds the second threshold. The terminal may then transmit a handover request to the target NTN cell and perform a subsequent handover procedure. Additionally, the threshold Th1-s for the RSRP of the serving TN cell and the threshold Th1-n for the RSRP of the neighboring TN cell may not be set to the same value as the first threshold. In other words, the value of Th1-s and the value of Th1-n may differ. For example, the value of Th1-s may be set smaller than the value of Th1-n.

FIG. 21 is a sequence chart illustrating a sixth exemplary embodiment of a handover method between NTN and TN.

As shown in FIG. 21, in a handover method between NTN and TN, information on boundary regions of TN cells serviced by base stations (i.e. terrestrial base stations) may be shared among the base stations. Here, the information on the boundary regions of TN cells may include location information of the boundary regions of TN cells.

Meanwhile, the terminal may receive GPS signals from GNSS satellites to determine the location of the terminal. The terminal may then transmit information on the determined location to the base station providing its services (e.g. base station 2). The base station 2 may receive the location information from the terminal and determine the location of the terminal. Here, although the base station 2 has been described as determining the location of the terminal by receiving the location information from the terminal, the present disclosure is not limited thereto, and other methods may also be used to determine the location.

Meanwhile, the base station 2 may determine whether the terminal is located in a boundary region of TN cells based on the determined location of the terminal and the location information of the boundary regions of TN cells. If the base station 2 determines that the terminal is located in a boundary region of TN cells, the base station 2 may transmit a measurement triggering signal to the terminal, instructing the terminal to initiate measurements on both the TN cells and the NTN cell (S2101).

The terminal may receive the measurement triggering signal from the base station 2. Meanwhile, the base station 2 may transmit CHO configuration information to the terminal to allow the terminal to perform a conditional handover (S2102). The terminal may then receive the CHO configuration information from the base station 2. The CHO configuration information may include information on thresholds, information on terrestrial base stations, and information on satellites. Here, the information on the base stations and satellites may include physical cell identifiers (PCIs) or the like.

In such a situation, the terminal may measure received signal strengths of terrestrial base stations (base stations 1 to base station n) and satellites (satellites 1 to satellite m) around the base station 2. Here, n and m may be positive integers. The received signal strength may be RSRP. Subsequently, the terminal may determine whether the received signal strengths (i.e. RSRPs) of the neighboring terrestrial base stations are below the first threshold (S2103). If the terminal determines that the received signal strengths of the neighboring terrestrial base stations are below the first threshold, the terminal may then determine whether there are received signal strengths (i.e. RSRPs) of satellites that exceed the second threshold (S2104). If the terminal determines that there are received signal strengths exceeding the second threshold, the terminal may decide to perform a handover to a satellite corresponding to the highest received signal strength (S2105). For example, the satellite corresponding to the highest received signal strength may be the satellite 1.

If it is decided that a handover procedure is to be performed, the terminal may transmit a handover request message to the satellite 1 (S2106). The handover request message may include at least one of BWP switching configuration information indicated to the terminal by the base station 2, a BWP switching combination indicated to the terminal by the base station 2, or information on a current BWP (e.g. operating BWP) between the terminal and the base station 2. The satellite 1 may receive the handover request message from the terminal and identify the information included in the handover request message. The satellite 1 may decide whether to approve the handover request (S2107). If the handover request is approved, the satellite 1 may generate BWP switching configuration information (e.g. BWP switching combination) for the satellite 1, considering the BWP switching configuration information of the base station 2.

The satellite 1 may transmit a handover response including the BWP switching configuration information (e.g. BWP switching combination) to the base station 2 (S2108). The base station 2 may receive the handover response from the satellite 1. Upon receiving the handover response, the base station 2 may determine that the handover request has been approved by the satellite 1. The base station 2 may generate a handover command message and transmit the handover command message to the terminal (S2109). The handover command message may include the BWP switching configuration information of the satellite 1.

Additionally, the handover command message may include at least a cell information element (IE) and all information required to access the satellite 1, allowing the terminal to access the satellite 1 without reading system information. Depending on a situation, the handover command message may include information required for contention-based and contention-free random access. The terminal may receive the handover command message from the base station 2 and identify the information included in the handover command message (e.g. BWP switching configuration information of the satellite 1).

The terminal may execute the CHO (S2110). In this case, the terminal may perform a detach procedure with the base station 2 and a synchronization procedure with the satellite 1. When the terminal is connected to the satellite 1, the terminal may perform communication with the satellite 1. In such a case, the terminal may perform a BWP switching operation based on the BWP switching configuration information included in the received handover command message. Subsequently, the terminal may transmit a handover complete message to the satellite 1. Accordingly, the satellite 1 may receive the handover completion message from the terminal. Here, the first threshold may be greater than the second threshold.

Meanwhile, in FIG. 15, the TN network service coverages may have a hole. In such a situation, the handover methods considering the boundary regions of TN cells, as described in FIGS. 16 to 21, may be applied without modification. Handover methods suitable for each of the handover scenarios in FIG. 14 and FIG. 15 may also be proposed. However, such handover methods may result in increased complexity. Therefore, a handover method that can be commonly applied to both the handover scenarios in FIG. 14 and FIG. 15 may be appropriate for implementation simplicity.

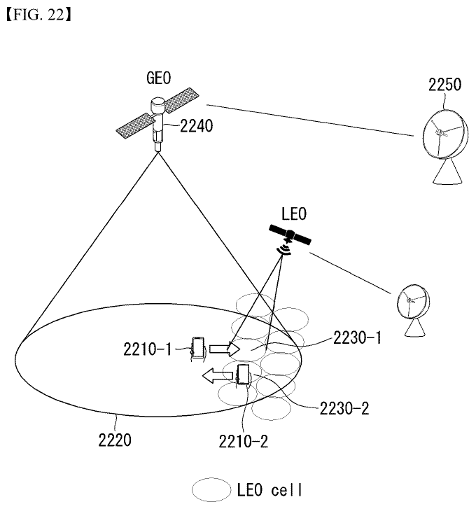

FIG. 22 is a conceptual diagram illustrating a third exemplary embodiment of a handover scenario.

As shown in FIG. 22, terminals 2210-1 and 2210-2 may move along a boundary of LEO service coverages 2230-1 and 2230-2. For example, the first terminal 2210-1 may move from a GEO service coverage 2220 served by a GEO satellite 2240 to an LEO service coverage 2230-1 served by a LEO satellite 2250. In this case, when the first terminal 2210-1 moves from the GEO service coverage 2220 to the LEO service coverage 2230-1, a handover from GEO to LEO may occur. Conversely, the second terminal 2210-2 may move from the LEO service coverage 2230-2 to the GEO service coverage 2220. When the second terminal 2210-2 moves from the LEO service coverage 2230-2 to the GEO service coverage 2220 as described above, a handover from LEO to GEO may occur.

Here, each of the terminals 2210-1 and 2210-2 may be a pedestrian, vehicle, or high-speed train on the ground, and in a broader sense, may be an airplane, PAV, or drone. As described above, the handover scenario in FIG. 22 may represent a situation where the GEO service coverage and the LEO service coverage partially overlap. This situation may be identical to the scenario in FIG. 14, except that it involves LEO-GEO instead of TN-NTN. In other words, a handover from GEO to LEO and a handover from LEO to GEO may correspond to a handover from NTN to TN and a handover from TN to NTN, respectively, as shown in FIG. 14. Therefore, the handover from GEO to LEO may apply the handover methods described in FIGS. 16 and 17. Conversely, the handover from LEO to GEO may apply the handover methods described in FIGS. 18 to 21.

Meanwhile, the location of the terminal may be stationary, while the satellite may be moving. In such a scenario, a handover from TN to NTN may occur. In cases where a handover is triggered by movement of the satellite, service by the currently serving satellite may end in all scenarios involving EFB and EMB. Additionally, there may not be a subsequent NTN satellite available. In this case, a handover to a TN cell may occur. In general, a terminal located in an NTN satellite service coverage may ensure service continuity through continuous handovers between NTN satellites. Therefore, an NTN-to-TN handover due to satellite movement may not need to be considered. If the movement of the terminal is not considered, TNs cell may continuously provide services to the terminal, and a TN-to-NTN handover may not be required.

On the other hand, the mobility of the terminal may be negligible compared to the movement and service coverage of LEO and GEO satellites. In other words, the location of the terminal may remain stationary. In such a scenario, a handovers between LEO and GEO satellites may occur due to the movement of the satellites. In this case, a handover from GEO to LEO may not be required, as the GEO coverage may remain fixed, and if the terminal's location is stationary, it may not leave the GEO coverage.

Next, a handover from LEO to GEO may be required. Describing this in more detail, the terminal may receive services from both NTN and TN. In this case, the serving LEO satellite may move, and there may be no subsequent LEO satellite available. As a result, a handover between LEO satellites may not occur. In such a case, a handover to a GEO satellite may be required. In typical NTN scenarios, service continuity for the terminal may be ensured through a handover between LEO satellites. Therefore, such handover may not occur.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1. A method of a user equipment (UE), comprising:
determining whether a measurement triggering condition for measurement objects is satisfied;
in response to the measurement triggering condition being determined to be satisfied, measuring reception signal strengths for the measurement objects;
transmitting the measured reception signal strengths to a base station;
receiving, from the base station, a handover command based on the reception signal strengths; and
performing a handover with one of the measurement objects according to the handover command,
wherein the measurement objects are terrestrial network base stations, and the base station is one of a non-terrestrial network base station and a terrestrial network base station.

2. The method according to claim 1, wherein the measurement objects further include non-terrestrial network base stations.

3. The method according to claim 1, wherein the determining of whether the measurement triggering condition for measurement objects is satisfied comprises:
receiving a measurement triggering signal for the measurement objects; and
in response to receipt of the measurement triggering signal, determining whether the measurement triggering condition is satisfied.

4. The method according to claim 1, wherein the determining of whether the measurement triggering condition for measurement objects is satisfied comprises:
determining whether the UE is close to a service boundary region of the measurement objects; and
determining whether the measurement triggering condition is satisfied based on whether the UE is close to the service boundary region of the measurement objects.

5. The method according to claim 4, wherein whether the UE is close to the service boundary region is determined based on at least one of information on locations of the measurement objects, information on locations of service coverages of the measurement objects, or information on cell radii of the measurement objects, and location information of the UE.

6. The method according to claim 1, wherein the measuring of the reception signal strengths for the measurement objects comprises:
in response to the measurement triggering condition being determined to be satisfied, determining a measurement time by considering a movement speed and direction of the UE; and
measuring the reception signal strengths for the measurement objects at the determined measurement time.

7. A method of a first base station, comprising:
determining whether a measurement triggering condition for measurement objects is satisfied;
in response to the measurement triggering condition being determined to be satisfied, transmitting a measurement triggering signal for the measurement objects to a user equipment (UE);
receiving, from the UE, measured reception signal strengths for the measurement objects;
transmitting, to a second base station, a handover request based on the reception signal strengths;
receiving a handover response to the handover request from the second base station; and
transmitting a handover command to the UE based on the handover response.

8. The method according to claim 7, wherein the measurement objects are terrestrial network base stations, and the first base station is a first non-terrestrial network base station.

9. The method according to claim 7, wherein the measurement objects are terrestrial network base stations and non-terrestrial network base stations, and the first base station is a terrestrial network base station.

10. The method according to claim 7, wherein the determining of whether the measurement triggering condition for measurement objects is satisfied comprises:
determining whether the UE is close to a service boundary region of the measurement objects; and
determining whether the measurement triggering condition is satisfied based on whether the UE is close to the service boundary region.

11. The method according to claim 10, wherein whether the UE is close to the service boundary region is determined based on at least one of information on locations of the measurement objects, information on locations of service coverages of the measurement objects, or information on cell radii of the measurement objects, and location information of the UE.

12. The method according to claim 7, wherein the transmitting of the handover request based on the reception signal strengths to the second base station comprises:
determining whether the reception signal strengths are less than a threshold;
in response to the reception signal strengths being determined to be less than the threshold, deciding a handover; and
transmitting a handover request to the second base station, which is one of the measurement objects.

13. The method according to claim 7, wherein the transmitting of the handover request based on the reception signal strengths to the second base station comprises:
determining whether reception signal strengths of terrestrial network base stations among the reception signal strengths are less than a first threshold;
in response to the reception signal strengths of the terrestrial network base stations being determined to be less than the first threshold, determining whether there is a reception signal strength of at least one non-terrestrial network base station among the reception signal strengths that exceeds a second threshold; and
transmitting a handover request to the second base station, which is the at least one non-terrestrial network base station that exceeds the second threshold.

14. A user equipment (UE) comprising at least one processor, wherein the at least one processor causes the UE to perform:
determining whether a measurement triggering condition for measurement objects is satisfied;
in response to the measurement triggering condition being determined to be satisfied, measuring reception signal strengths for the measurement objects;
transmitting the measured reception signal strengths to a base station;
receiving, from the base station, a handover command based on the reception signal strengths; and
performing a handover with one of the measurement objects according to the handover command,
wherein the measurement objects are terrestrial network base stations, and the base station is one of a non-terrestrial network base station and a terrestrial network base station.

15. The UE according to claim 14, wherein in the determining of whether the measurement triggering condition for measurement objects is satisfied, the at least one processor further causes the UE to perform:
receiving a measurement triggering signal for the measurement objects; and
in response to receipt of the measurement triggering signal, determining whether the measurement triggering condition is satisfied.

16. The UE according to claim 14, wherein in the determining of whether the measurement triggering condition for measurement objects is satisfied, the at least one processor further causes the UE to perform:
determining whether the UE is close to a service boundary region of the measurement objects; and
determining whether the measurement triggering condition is satisfied based on whether the UE is close to the service boundary region of the measurement objects.

17. The UE according to claim 14, wherein in the measuring of the reception signal strengths for the measurement objects, the at least one processor further causes the UE to perform:
in response to the measurement triggering condition being determined to be satisfied, determining a measurement time by considering a movement speed and direction of the UE; and
measuring the reception signal strengths for the measurement objects at the determined measurement time.
